(19) United States
(12) Patent Application Publication
(10) Pub. No.: US 2004/0107180 A1
(43) Pub. Date: Jun. 3, 2004

(54) Delivery-information management process and information management server

(76) Inventor: Atsushi Yoshida, Kawasaki (JP)

Correspondence Address: GREER, BURNS & CRAIN, 300 S WACKER DR, 25TH FLOOR, CHICAGO, IL, 60606, US

(21) Appl. No.: 10/672,295

(22) Filed: Sep. 26, 2003

(30) Foreign Application Priority Data
Sep. 30, 2002 (JP) 2002-286401

(51) Int. Cl. G06F 7/00

(52) U.S. Cl. 707/1

(57) ABSTRACT

A delivery-information management process which enables flexible and objective evaluation with respect to reliability of information which is shared or exchanged. In the delivery-information management process: a rule for evaluation of information is set for an information group; an information item having a predetermined attribute is classified into the information group; an evaluation value of the information group is calculated by applying the rule for evaluation of information to the information item; and the evaluation value is stored in a database in association with the information group.

### BACKGROUND OF THE INVENTION

1) Field of the Invention

The present invention relates to a delivery-information management process and an information management server for managing information to be delivered through a network. In particular, the present invention relates to a delivery-information management process and an information management server for publishing an evaluation of information to be delivered.

2) Description of the Related Art

When the recent information and communications technologies are utilized, it is possible to easily exchange information with unspecific parties. Settings for information exchange are provided on a network for various purposes. For example, the following settings are provided for exchange of information.

(i) Settings for exchanging information for investigation, product development, and the like in companies

(ii) Settings for exchanging information on a specific theme in services between company and customer

(iii) Settings for exchanging event information for each area and theme in local governments and public corporations

(iv) Settings for exchanging information in electronic shopping malls

(v) Settings for exchanging information for evaluation and the like, by administrators, of exhibitors of online auction sites

In the above settings for information exchange, unspecific participants provide information. The following are examples of methods of information exchange.

(a) Question-and-answer Type Knowledge Exchange Community

There are systems in which one or more answerers provide one or more answers to a question from a questioner, and the one or more answers are evaluated based on one or more levels of the questioner's satisfaction with the one or more answers. The one or more levels of the questioner's satisfaction are collected by one or more questionnaires through a webpage or e-mail addressed to the questioner. In many case where a plurality of answerers answer the question, a transaction is conducted in such a manner that the questioner buys an answer corresponding to the highest one of the levels of the questioner's satisfaction, which are determined according to the questioner's subjective point of view.

(b) Ranking Type Knowledge Exchange Community

There are systems in which information items provided by information providers are ranked based on an average or sum of subjective evaluations by respective participants, where the information items are evaluated based on the levels of the participants' satisfaction determined according to the participants' subjective points of view. In this case, reliability of transmission of the information is not particularly required. Currently, in most cases, information on a location of information such as a website is provided, and information obtained by questionnaires through the Internet or frequencies of access are utilized as ranking information. Further, in another case, a form for evaluation of a homepage is sent to each user, and the user evaluates the homepage in accordance with the form of evaluation (see, for example, Japanese Unexamined Patent Publication No. 2001-92742).

(c) Electronic Message Boards in Web Services and Groupware

There are web sites for information exchange, which are arranged to provide a place for sharing of information and discussions by specific or unspecific people. In many electronic message boards, reliability of transmission of the information is not considered, and the information is not particularly evaluated.

(d) Evaluation of Exhibitors and Purchasers in Internet Auctions

In Internet auctions, commodities are traded without meeting between a seller and a buyer. Therefore, evaluation systems are used as means for measuring credibility of trading partners. That is, when a transaction is conducted, trading partners are evaluated by each other. When a trading partner is positively evaluated, a point is given to the trading partner. Then, third parties can recognize the credibility of exhibitors and intending purchasers based on the points which the exhibitors and intending purchasers have obtained in the past transactions. For example, it is possible to consider that information (e.g., an explanation of a commodity) provided by a reliable exhibitor is reliable. The auction site administrated by Yahoo Japan Corporation is an example of an Internet auction site utilizing an evaluation system as above (see “Yahoo!Auction Help, What is the evaluation in Yahoo!Auctions,” at the URL: http://help.yahoo.co.jp/help/jp/auct/amisc/amisc39.html, which was referred to by the applicant on Sep. 22, 2002).

Incidentally, sometimes disclosed information contains wrong information. However, in the case where users arbitrarily evaluate information as in the conventional systems, only subjective views of the users are reflected in the evaluations, and therefore the evaluations per se are not reliable.

Specifically, evaluation of information is required to be more reliable for the following reasons.

(i) Ensuring of Quality of Provided Information

Currently, substantially no measure is taken for ensuring quality of provided information (i.e., correctness of information and sufficiency of the contents), and therefore the quality of provided information depends on the morals of the information provider.

(ii) Setting of Flexible Evaluation Criteria for Information and Information Providers

Currently, evaluation criteria for information and information providers are not clarified. In most cases, information and information providers are evaluated based on results of questionnaires to users on provided information or frequencies of access to information, and therefore the evaluation is highly subjective.

In addition, in most cases, an identical evaluation criterion is used for all types of information, and no evaluation criterion adapted to characteristics of information is particularly considered.

(iii) Realization of Reliable and Flexible Delivery of Information to Users

In many conventional services, users refer by themselves to a place in which information is provided. Since information is delivered by e-mail, users of information are likely to overlook the information. Further, in order to flexibly change the delivery range, it is necessary to prepare a plurality of mailing lists in a mail base, and perform complicated operations for management of the mailing lists.

As explained above, the evaluations according to the conventional evaluation processes are based on subjective or fixed evaluation criteria. Therefore, it is impossible to make an objective evaluation which is flexibly adapted to change in the circumstances or the like. In addition, the conventional processes of delivering information are also fixed, and inconvenient.

### SUMMARY OF THE INVENTION

The present invention is made in view of the above problems, and the object of the present invention is to provide a delivery-information management process which enables flexible and objective reliability evaluation of shared or exchanged information, and an information management server for performing the delivery-information management process.

In order to accomplish the above object, a delivery-information management process is provided for managing information which is to be delivered through a network, by using a computer. The delivery-information management process comprises the steps of: (a) setting a rule for evaluation of information for an information group; (b) classifying an information item having a predetermined attribute into the information group; (c) calculating an evaluation value of the information group by applying the rule for evaluation of information to the information item; and (d) storing the evaluation value in a database in association with the information group.

Further, in order to accomplish the above object, an information management server for managing information which is to be delivered through a network is provided. The information management server comprises: an evaluation-rule setting unit which sets a rule for evaluation of information for an information group; an information classifying unit which classifies an information item having a predetermined attribute into the information group; an evaluation-value calculation unit which calculates an evaluation value of the information group by applying the rule for evaluation of information to the information item; and an information storing unit which stores the evaluation value in a database in association with the information group.

The above and other objects, features and advantages of the present invention will become apparent from the following description when taken in conjunction with the accompanying drawings which illustrate preferred embodiment of the present invention by way of example.

### BRIEF DESCRIPTION OF THE DRAWINGS

In the drawings:

FIG. 1 is a conceptual diagram illustrating the present invention which is realized in an embodiment;

FIG. 2 is a conceptual diagram illustrating the embodiment of the present invention;

FIG. 3 is a diagram illustrating an example of a system construction of the embodiment;

FIG. 4 is a diagram illustrating an example of a hardware construction of an information management server;

FIG. 5 is a diagram illustrating an example of a data structure of an information group;

FIG. 6 is a diagram illustrating an example of a data structure of a registered information item;

FIG. 7 is a diagram illustrating an example of a data structure of a rule set;

FIG. 8 is a conceptual diagram illustrating a manner of registration of information on an information provider;

FIG. 9 is a flowchart indicating a sequence of processing for registration of an information provider;

FIG. 10 is a flowchart indicating a sequence of processing for modifying provider information;

FIG. 11 is a conceptual diagram illustrating a manner of registration of information on an information user;

FIG. 12 is a flowchart indicating a sequence of processing for registration of an information user;

FIG. 13 is a flowchart indicating a sequence of processing for modifying user information;

FIG. 14 is a conceptual diagram illustrating processing for registration of information;

FIG. 15 is a flowchart indicating a sequence of the processing for registration of information;

FIG. 16 is a flowchart indicating a sequence of processing for modification of registered information;

FIG. 17 is a conceptual diagram illustrating processing for delivery of information;

FIG. 18 is a flowchart indicating a first half of a sequence of processing for automatic delivery of information;

FIG. 19 is a flowchart indicating a second half of the sequence of processing for automatic delivery of information;

FIG. 20 is a conceptual diagram illustrating the processing for evaluation of an information item;

FIG. 21 is a flowchart indicating a sequence of processing for evaluation of an information item;

FIG. 22 is a flowchart indicating a first half of a sequence of processing for newly producing an information group;

FIG. 23 is a flowchart indicating a second half of the sequence of processing for newly producing the information group;

FIG. 24 is a diagram illustrating an example of application to an event-information issuing site;

FIG. 25 is a diagram illustrating an example of an information-exchange service in an electronic commerce (e-commerce) site;

FIG. 26 is a diagram illustrating an example of a network auction service;

FIG. 27 is a diagram illustrating a concrete example of a registered information item;

FIG. 28 is a diagram illustrating a concrete example of a rule for association between information items;

FIG. 29 is a diagram illustrating a concrete example of a rule for detection and resolution of inconsistency;

FIG. 30 is a diagram illustrating a rule for evaluating an information item before a start of a campaign period;

FIG. 31 is a diagram illustrating an example of an operation of an information-evaluation agent before a start of a campaign period;

FIG. 32 is a diagram illustrating a rule for evaluating an information item during a campaign period;

FIG. 33 is a flowchart indicating a sequence of processing for calculation of an evaluation point when an information item is evaluated;

FIG. 34 is a diagram illustrating an example of an operation of the information-evaluation agent during a campaign period;

FIG. 35 is a diagram illustrating an example of a rule for re-evaluation of an information group before a start of a campaign period;

FIG. 36 is a diagram illustrating an example of a rule for re-evaluation of an information group during a campaign period;

FIG. 37 is a diagram illustrating an example of a rule for evaluation of an information provider, where the evaluation is made in response to a purchase request during a campaign period; and

FIG. 38 is a diagram illustrating an example of a rule for evaluation of an information provider, where the evaluation is made in response to cancellation of a purchase request during a campaign period.

### DESCRIPTION OF THE PREFERRED EMBODIMENTS

An embodiment of the present invention is explained below with reference to drawings.

First, an outline of the present invention which is realized in the embodiment is explained, and thereafter details of the embodiment are explained.

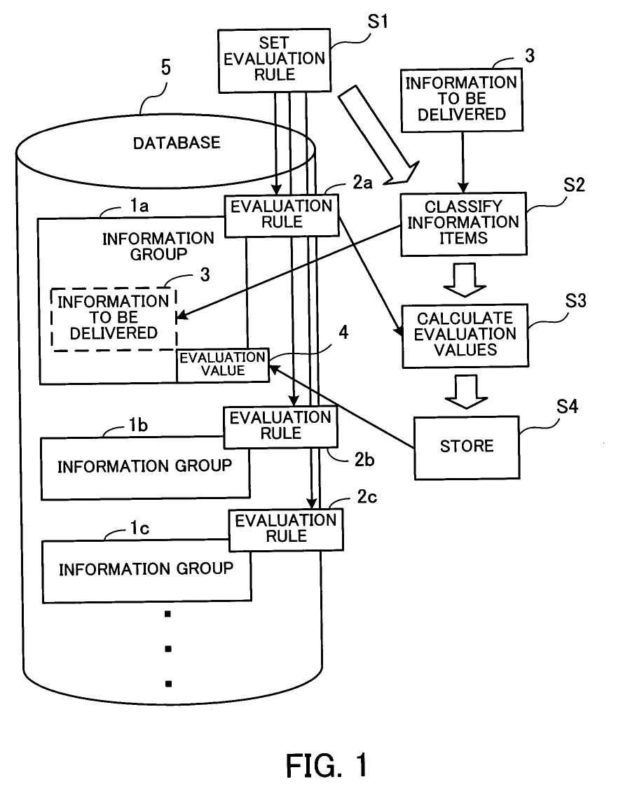

FIG. 1 is a conceptual diagram illustrating the present invention which is realized in the embodiment. In the present embodiment, the following processing is performed by using a computer.

In step S1, evaluation rules 2a, 2b, and 2c for evaluation of information are set for information groups 1a, 1b, and 1c, respectively. The evaluation rules 2a, 2b, and 2c are provided for evaluating the information groups 1a, 1b, and 1c based on information contained in the information groups 1a, 1b, and 1c, respectively. For example, formulas for calculation of evaluation values based on evaluation points given by information users who have referred to information 3 to be delivered are defined in the evaluation rules 2a, 2b, and 2c, respectively. In addition, it is also possible to define in the evaluation rules 2a, 2b, and 2c methods of calculation of evaluation values based on evaluation points given by information users who have referred to the information 3 to be delivered and statistical information on the information 3 to be delivered.

Next, in step S2, an item of information 3 which is to be delivered and has a predetermined attribute is classified into the information group 1a. Then, in step S3, the evaluation rule 2a is applied to the item of information 3 classified into the information group 1a, and an evaluation value 4 of the information group 1a is calculated. For example, every time a new item of information 3 which is to be delivered and has the predetermined attribute is classified into the information group 1a, the evaluation value 4 of the information group 1a is updated based on an evaluation value of the new item of information 3.

When the evaluation value is calculated, in step S4, the evaluation value 4 is stored in a database 5 in association with the information group 1a.

Thus, items of information 3 which are to be delivered and have the predetermined attribute are classified into the same information group 1a, the evaluation value 4 of the information group 1a is set based on an appropriate evaluation rule corresponding to the predetermined attribute. Therefore, it is possible to obtain a reliable evaluation of the information group 1a. In addition, since an evaluation rule for each information group 1a can be arbitrarily set, it is possible to use a flexible rule in evaluation of information.

Further, in the present embodiment, the following processing is performed as well as the processing illustrated in FIG. 1.

(a) More than one evaluation rule can be used. At this time, the more than one evaluation rule forms a rule set. Further, it is possible to define the more than one evaluation rule by functions (evaluation functions).

(b) Each information group is evaluated (reevaluated) based on evaluation results of individual information items belonging to the information group. In order to make the re-evaluation, a rule set for re-evaluation is associated with each information group in advance.

(c) It is possible to set delivery conditions of information items contained in each information group. For example, a rule set for determining a start and a stop of delivery is associated with each information group, and information items belonging to each information group are delivered in only a delivery period determined by the rule set.

(d) A rule set for determining whether or not delivery to a destination (user of information) is to be made is associated with each information group. Thus, it is possible to set information indicating whether or not delivery is to be made according to the attribute of the destination (user of information).

(e) A rule set for association between information items is associated with each information group. Thus, it is possible to realize association between information items in accordance with the rules for association. In addition, when information items are associated with each other, useful information items can be easily detected and delivered to users of information.

(f) A template of a registered information item and functions of input data checks and automatic data complement are provided to each information group. When a template for registration of an information item is provided, it is possible to prevent omission of data input and the like. In addition, when information is inputted by using the template, it is possible to easily automatize checking of inputted data.

(g) A rule set for checking each information group for inconsistency between information items in the information group and a rule set for resolving the inconsistency are associated with the information group. Thus, inconsistency with an information item registered in the past is detected. For example, when there is a discrepancy in details between different specifications of an identical product (e.g., when different numbers of pixels are indicated in two specifications of an identical digital camera), it is possible to determine inconsistency. When inconsistency is determined, it is possible to prevent delivery of a wrong information item by letting an information provider choose a correct information item, and removing the wrong information item. For example, information items in an identical information group or information items associated with each other are subject to the checking for inconsistency.

(h) A rule set or evaluation functions for indicating evaluation criteria are associated with each information provider. It is possible to convert a degree of reliability of an information provider into a number by making an evaluation of the information provider.

(i) An agent for delivering information with high reliability (which is a resident program for delivery of information) is associated with each information user. When the agent detects a time to deliver information, the agent delivers the information to a user of the information. Thus, it is possible to deliver information to a user needing the information with high reliability.

(j) A rule set or functions for individually evaluating each information item at the time of registration are chosen and assigned to the information item at the time of registration. Thus, in the case where each information item is evaluated when the information item is registered, it is possible to provide information on reliability of each information item even when the information item is new.

(k) A rule set for determining a start and a stop of delivery is chosen and assigned to each information item at the time of registration. Since the delivery periods of information items are limited, it is possible to prevent delivery of an information item which is useless due to untimeliness (e.g., an information item on a campaign after expiration of the campaign period).

(l) A rule set for determining whether or not delivery to a destination (user of information) is to be made is chosen and assigned to each information item at the time of registration. Since the destinations of information items are limited, for example, it is possible to deliver information to a club member (e.g., a notification of a next date of activity), and the like. Further, it is also possible to assign to each information group a rule set for determining whether or not delivery to a destination is to be made. For example, a rule for determining whether or not delivery to a destination is to be made dynamically determines whether or not delivery to a destination is to be made (i.e., the extent of the delivery), based on information on a user and an attribute of information to be delivered.

(m) An evaluation of each information group per se is recalculated by using evaluation results of information items and a rule set or functions for re-evaluation.

(n) An evaluation of each information provider is recalculated by using evaluation results of information items and a rule set or functions for re-evaluation.

Details of the present embodiment having the above functions are explained below.

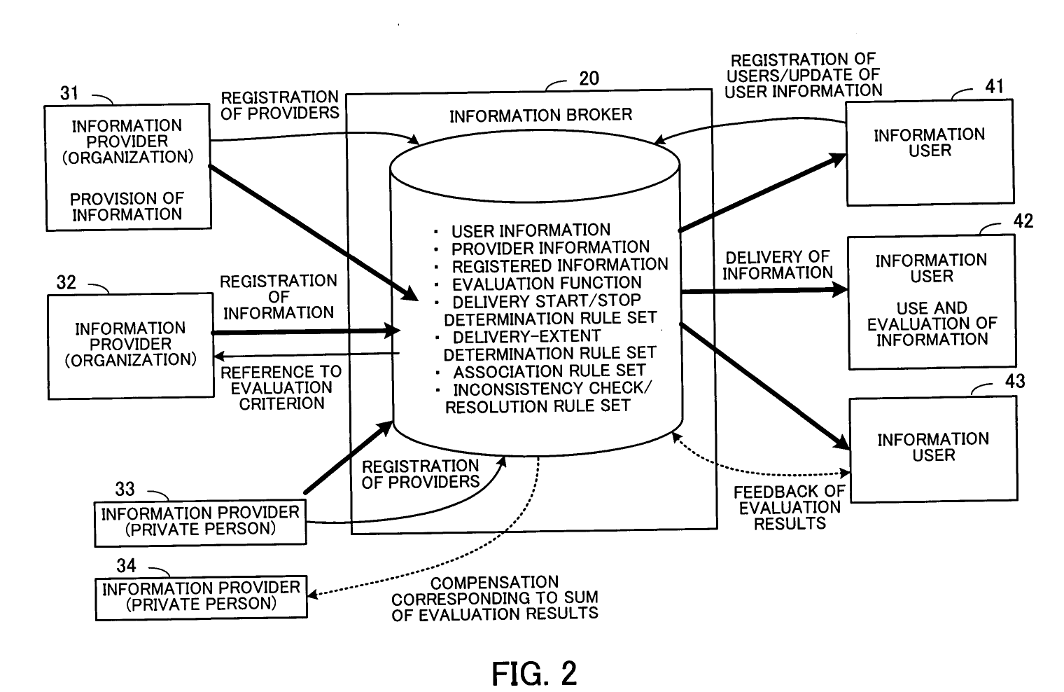

FIG. 2 is a conceptual diagram illustrating the present embodiment. In the present embodiment, an information broker 20 is a unit which evaluates information, and provides a result of the evaluation. In the information broker 20, information providers 31 to 34 per se and information provided by the information providers 31 to 34 are registered. The information providers 31 and 32 are each a business enterprise which provides information, and the information providers 33 and 34 are each a private person who provides information. The information providers 31 to 34 can refer to evaluation criteria for information registered in the information broker 20. In addition, the information broker 20 may make a remuneration corresponding to a sum of evaluation results for each of the information providers 31 to 34.

The information registered in the information broker 20 is delivered to information users 41 to 43 who have performed user registration, update of user information, or the like. Thus, each of the information users 41 to 43 can receive a service for notifying of registration of information which the information user wishes to receive, or delivering the information, when the information is registered. In addition, each of the information users 41 to 43 can send to the information broker 20 an evaluation of information which the information user uses, and receive an evaluation result fed back from the information broker 20 (refer to an overall evaluation result of information).

The information managed by the information broker 20 includes items of “USER INFORMATION,” “PROVIDER INFORMATION,” “REGISTERED INFORMATION,” “EVALUATION FUNCTION,” “DELIVERY START/STOP DETERMINATION RULE SET,” “DELIVERY-EXTENT DETERMINATION RULE SET,” “ASSOCIATION RULE SET,” “INCONSISTENCY CHECK/RESOLUTION RULE SET,” and the like. The item “USER INFORMATION” is information on users of information managed by the information broker 20, the item “PROVIDER INFORMATION” is information on information providers, the item “REGISTERED INFORMATION” is information on registered information, the item “EVALUATION FUNCTION” is information defining at least one rule for evaluating information, the item “DELIVERY START/STOP DETERMINATION RULE SET” is information defining at least one rule for determining a start and a stop of delivery of information, the item “DELIVERY-EXTENT DETERMINATION RULE SET” is information defining at least one rule for determining at least one user which can receive an information item, the item “ASSOCIATION RULE SET” is information indicating association between information providers and at least one rule set or at least one evaluation function representing at least one evaluation criterion, and the item “INCONSISTENCY CHECK/RESOLUTION RULE SET” is information defining at least one rule for checking and resolving inconsistency in information.

The difference between the present embodiment and the aforementioned question-and-answer type knowledge exchange community exists in the procedure of a question and an answer. In the question-and-answer type knowledge exchange community, a questioner first issues a question, and then waits for an answer to the question from an answerer. That is, basically, an information provider does not provide information until a question belonging to a field in which the information provider specializes is issued. On the other hand, in the present embodiment, each information provider actively provides at least one information item, and each information user receives delivery of at least one information item from among information items provided by information providers.

The present embodiment is different from the aforementioned ranking type knowledge exchange community in flexibility of information evaluation. In the ranking type knowledge exchange community, fixed evaluation criteria are used for ranking. On the other hand, in the present embodiment, various rule sets are prepared so that an appropriate rule can be used whenever necessary.

Various information is transmitted among the information broker 20, the information providers 31 to 34, and the information users 41 to 43 through a computer network such as the Internet.

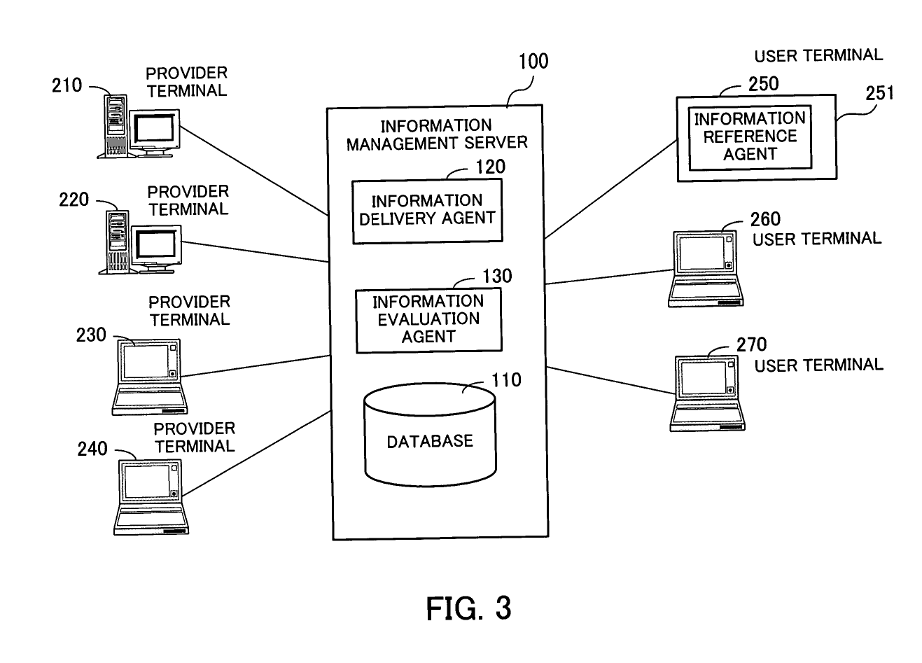

FIG. 3 is a diagram illustrating an example of a system construction of the present embodiment. As illustrated in FIG. 3, the system of the present embodiment comprises an information management server 100, provider terminals 210, 220, 230, and 240, and user terminals 250, 260, and 270. The information management server 100 is a computer managed by the information broker 20. The provider terminals 210, 220, 230, and 240 are computers managed by the information providers 31, 32, 33, and 34, respectively. The user terminals 250, 260, and 270 are computers managed by the information users 41, 42, and 43, respectively.

The information management server 100 comprises a database 110, an information delivery agent 120, and an information evaluation agent 130. The database 110 stores various information to be managed by the information broker 20. The information delivery agent 120 delivers at least one information item stored in the database 110 to the user terminal 250, 260, or 270 by using a delivery means specified by an information user. The information evaluation agent 130 performs processing for evaluation of reliability of information stored in the database 110, checking for inconsistency in the information, and the like.

The user terminal 250 has an information reference agent 251, which receives an evaluation of information through interactive processing with the information user 41, and sends details of the evaluation to the information management server 100. Although not shown in FIG. 3, the other user terminals 260 and 270 also have a similar information reference agent.

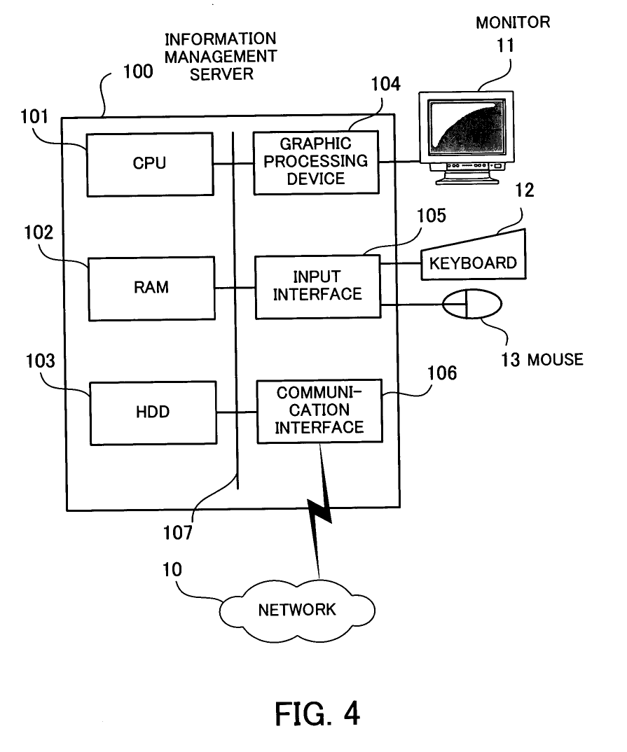

FIG. 4 is a diagram illustrating an example of a hardware construction of the information management server. The entire system of the information management server 100 is controlled by a CPU (central processing unit) 101, to which a RAM (random access memory) 102, an HDD (hard disk drive) 103, a graphic processing device 104, an input interface 105, and a communication interface 106 are connected through a bus 107.

The RAM 102 temporarily stores at least a portion of an OS (operating system) program and application programs which are executed by the CPU 101, as well as various types of data which are necessary for the CPU 101 to perform processing. The HDD 103 stores the OS program and the application programs.

A monitor 11 is connected to the graphic processing device 104, which makes the monitor 11 display an image on an screen in accordance with an instruction from the CPU 101. A keyboard 12 and a mouse 13 are connected to the input interface 105, which transmits signals transmitted from the keyboard 12 and the mouse 13, to the CPU 101 through the bus 107.

The communication interface 106 is connected to an network 10. The communication interface 106 is provided for exchanging data with other computers through the network 10.

By using the above hardware construction, it is possible to realize processing functions in the present embodiment. In addition, each of the provider terminals 210, 220, 230, and 240 and the user terminals 250, 260, and 270 can also be realized by using a hardware construction similar to that illustrated in FIG. 4.

In the above system, each of the information providers 31 to 34 automatically or manually registers in the information management server 100 an information item which the information provider can provide. Information items registered in the information management server 100 are classified into groups, and an evaluation function, a condition for starting delivery, a condition for stopping delivery, a condition for linkage to related information, and a condition for checking for inconsistency are associated with each group.

In addition, at the time of registration, an operation of association is performed if it is possible at that time, and an operation of checking for inconsistency is performed on an information item which is to be checked for inconsistency.

Further, an evaluation function is associated with an information provider. Every time an evaluation point of a provided information item is recalculated, an evaluation point of the information provider of the provided information is also recalculated. In addition to evaluation of each information item at the time of reference to the information item, in some cases, an evaluation of information is inputted again after a predetermined time elapses. This function is specified as an evaluation function.

Next, classification of registered information into groups is explained below.

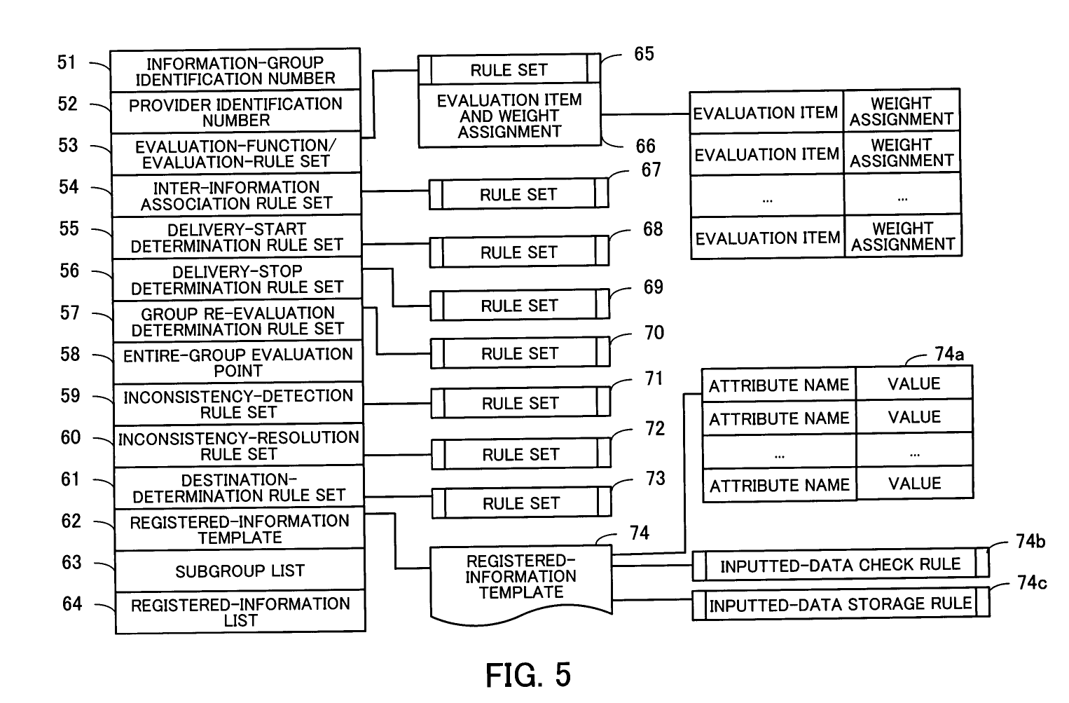

FIG. 5 is a diagram illustrating an example of a data structure of an information group. In each information group, information is managed in items of an information-group identification number 51, a provider identification number 52, an evaluationfunction/evaluation-rule set 53, an inter-information association rule set 54, a delivery-start determination rule set 55, a delivery-stop determination rule set 56, a group re-evaluation determination rule set 57, an entire-group evaluation point 58, an inconsistency-detection rule set 59, an inconsistency-resolution rule set 60, a destination-determination rule set 61, a registered-information template 62, a subgroup list 63, a registered-information list 64, and the like.

The item of the information-group identification number 51 indicates an identification number for uniquely identifying an information group. The item of the provider identification number 52 indicates an identification number for uniquely identifying a provider of a registered information item belonging to an information group.

The item of the evaluation-function/evaluation-rule set 53 indicates a set of evaluation functions or evaluation rules for evaluating a registered information item belonging to an information group, and associated with a rule set 65, which is a set of applicable rules. The item of the rule set 65 contains evaluation items and weight information 66. A portion of the evaluation items in the rule set 65 can be utilized as evaluation items in questionnaires on users' evaluations.

The item of the inter-information association rule set 54 indicates a set of rules for association between registered information items, and associated with a rule set 67, which is a set of applicable rules. The item of the delivery-start determination rule set 55 indicates a set of rules for determining a time to start delivery, and associated with a rule set 68, which is a set of applicable rules. The item of the delivery-stop determination rule set 56 indicates a set of rules for determining a time to stop delivery, and associated with a rule set 69, which is a set of applicable rules. The item of the group re-evaluation determination rule set 57 indicates a set of rules for re-evaluating a group, and associated with a rule set 70, which is a set of applicable rules. The item of the entire-group evaluation point 58 is an evaluation point of the entire group. The item of the inconsistency-detection rule set 59 indicates a set of rules for detecting inconsistency, and associated with a rule set 71, which is a set of applicable rules. The item of the inconsistency-resolution rule set 60 indicates a set of rules for resolving inconsistency, and associated with a rule set 72, which is a set of applicable rules. The item of the destination-determination rule set 61 indicates a set of rules for determining a destination of a registered information item, and associated with a rule set 73, which is a set of applicable rules.

The item of the registered-information template 62 indicates a template used in registration of information, and associated with a registered-information template 74, which is applicable. The registered-information template 74 is associated with a table 74a of correspondences between names and values of attributes, an inputted-data check rule 74b, and an inputted-data storage rule 74c. Since each registered information item is identified by a combination of values of a plurality of attributes, names of attributes which can be registered in each group is defined in the registered-information template 74, so that it is possible to prevent registration of an incorrect attribute.

In the case where groups in a subordinate structure (i.e., subgroups) exist, identification information for identifying each subgroup is set in the subgroup list 63.

Identification information identifying each registered information item belonging to each group is set in the registered-information list 64.

As mentioned above, the information groups can be further classified into a plurality of groups corresponding to a plurality of categories. That is, groups can be hierarchized.

In addition, it is possible to associate each information group with an evaluation function for evaluating a registered information item belonging to the information group, a function for realizing association between information items, a function for specifying a condition for starting delivery of information, a function for specifying a condition for stopping delivery of information, a function for detecting inconsistency between information items, and a function for specifying an extent of delivery. These functions are used for checking whether or not delivery is possible before the delivery, association between information items at the time of registration of the information items, and detection of inconsistency in the information items at the time of registration of the information items. Thus, for example, quality of information is ensured, and delivery is controlled.

Further, a template for inputting an information item to be registered is provided for each information group. Thus, the format of the information is unified, and the input operations are facilitated. When an information group is a subgroup of another information group, it is possible to inherit from the superior group, evaluation functions, a function for association, a condition for starting delivery, a condition for stopping delivery, a function for detecting inconsistency, and a template for registered information. Thus, setup of a new information group is facilitated. The points are managed by associating the information groups with the functions and the templates.

Next, the data structure of a registered information item is explained below.

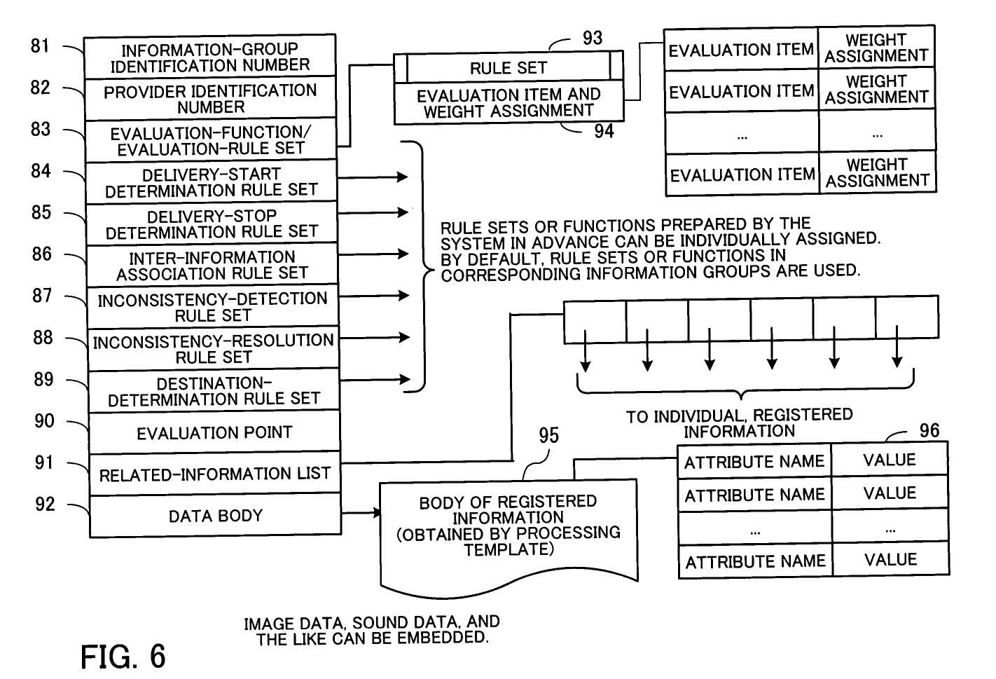

FIG. 6 is a diagram illustrating an example of a data structure of a registered information item. In each registered information item, information is managed in items of an information-group identification number 81, a provider identification number 82, an evaluation-function/evaluation-rule set 83, a delivery-start determination rule set 84, a delivery-stop determination rule set 85, an inter-information association rule set 86, an inconsistency-detection rule set 87, an inconsistency-resolution rule set 88, a destination-determination rule set 89, an evaluation point 90, a related-information list 91, a data body 92, and the like.

The item of the information-group identification number 81 indicates an identification number for identifying an information group to which the registered information item belongs. The item of the provider identification number 82 indicates an identification number for uniquely identifying a provider of the registered information item.

The item of the evaluation-function/evaluation-rule set 83 indicates a set of evaluation functions or evaluation rules for evaluating the registered information item, and associated with a rule set 93, which is a set of applicable rules. The item of the rule set 93 contains evaluation items and weight assignment information 94. A portion of the evaluation items in the rule set 93 can be utilized as evaluation items in questionnaires on users' evaluations.

The item of the delivery-start determination rule set 84 indicates a set of rules for determining a time to start delivery, and associated with a rule set, which is a set of applicable rules. The item of the delivery-stop determination rule set 85 indicates a set of rules for determining a time to stop delivery, and associated with a rule set, which is a set of applicable rules. The item of the inter-information association rule set 86 indicates a set of rules for association between registered information items, and associated with a rule set, which is a set of applicable rules. The item of the inconsistency-detection rule set 87 indicates a set of rules for detecting inconsistency, and associated with a rule set, which is a set of applicable rules. The item of the inconsistency-resolution rule set 88 indicates a set of rules for resolving inconsistency, and associated with a rule set, which is a set of applicable rules. The item of the destination-determination rule set 89 indicates a set of rules for determining a destination of the registered information item, and associated with a rule set, which is a set of applicable rules.

In the item of the evaluation point 90, an evaluation point of the registered information item is set. In the item of the related-information list 91, a list of other registered information items which are determined to be related to the registered information item based on the rules for association between registered information items is set. In the data body 92, the body 95 of the registered information item is set.

The body 95 of the registered information item has a form in which necessary information is written in a template for the group to which the registered information item belongs. Therefore, as in the case of the template, the body 95 of the registered information item contains a table 96 of correspondences between names and values of attributes. In addition, the body 95 can contain moving image data and/or sound data.

The rules applied to each registered information item can be set by assigning to each of the items 83 to 89 a rule set which has been prepared in the system in advance. However, when no arbitrary rule set is assigned to one or more of the items 83 to 89, one or more rule sets set in one or more corresponding items (in FIG. 5) for an information group to which the registered information item belongs are applied by default. In other words, although each registered information item uses, by default, functions which are set for an information group to which the registered information item belongs, it is possible to individually set functions for each registered information item.

In addition, at the time of registration of information, an operation for association between information items is performed by referring to the rule set for association between information items, although it is possible to configure the system so that the operation for association is not performed. Further, when a function for detecting inconsistency is specified, an operation of checking inconsistency between information items in an identical group can be performed at the time of registration. Thus, quality of information can be secured.

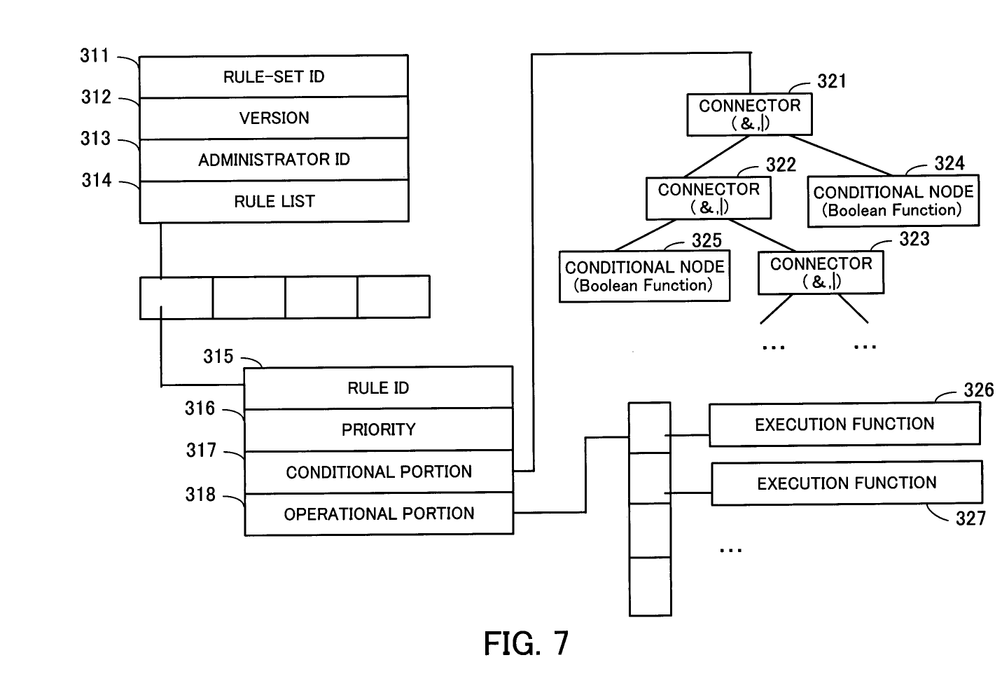

FIG. 7 is a diagram illustrating an example of a data structure of a rule set. The rule set of FIG. 7 comprises a rule-set ID 311, a version 312, an administrator ID 313, and a rule list 314. The rule-set ID 311 is identification information for uniquely identifying the rule set. The version 312 is the version number of the rule set. The administrator ID 313 is identification information for identifying an administrator of the rule set. The rule list 314 is a list of rules included in the rule set.

Each of the rules included in the rule list 314 is constituted by a rule ID 315, a priority 316, a conditional portion 317, and an operational portion 318. The rule ID 315 is identification information for uniquely identifying the rule. The priority 316 is a priority of application of the rule. When a plurality of rules which cannot be concurrently applied are set, one of the plurality of rules which has the highest priority is applied.

The conditional portion 317 is information indicating a condition for application of the rule. For example, the conditional portion 317 defines a tree structure, which is constituted by logical connectors (logical sums or logical products) 321 to 323 corresponding to nodes of the tree structure and conditional nodes 324 and 325 corresponding to leaves (ends of the tree structure). In the case where the logical connectors 321 to 323 calculate logical sums, a result of a judgement made at each of the logical connectors 321 to 323 becomes true in the case where a condition which is set in one of a plurality of subordinate structures branched from the logical connector is satisfied (i.e., true). On the other hand, in the case where the logical connectors 321 to 323 calculate logical products, a result of a judgement made at each of the logical connectors 321 to 323 becomes true in the case where all of conditions which are set in a plurality of subordinate structures branched from the logical connector are satisfied (i.e., true). Boolean functions are set in the conditional nodes 324 and 325, and the judgements by the Boolean functions become true when an information item subject to the judgements matches the Boolean functions. Therefore, when judgements of each registered information item are made at the respective nodes of the tree structure in ascending order of superiority in the tree structure, and finally the result of the judgement made at the logical connector 321 becomes true, it is determined that the registered information item satisfies the condition for application of the rule.

The operational portion 318 is information indicating details of processing which is to be performed when an information item satisfies the condition for application of the rule. In the operational portion 318, a plurality of execution functions 326, 327, . . . define the details of processing.

Next, a manner of registering information on information providers is explained below.

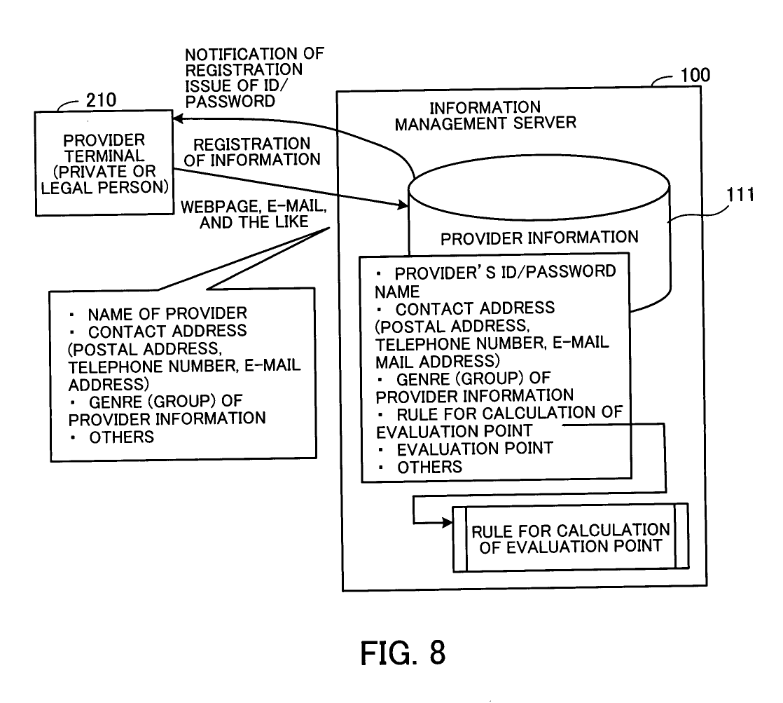

FIG. 8 is a conceptual diagram illustrating a manner of registration of information on an information provider. In the example illustrated in FIG. 8, an information provider 31 registers information on the information provider 31 by using the provider terminal 210.

That is, the information provider 31 accesses the information management server 100 by using the provider terminal 210, and registers information on the information provider 31 by using the provider terminal 210. The registration can be realized by e-mail or access to a webpage which is presented by the information management server 100. The registered information contains the name of the information provider, a contact address (including a postal address, a telephone number, and a mail address), a genre of provided information (an information group to which the provided information belongs), and the like. When the information is registered, the information management server 100 issues a notification of registration to the provider terminal 210, where the notification contains a provider ID, a password, and the like.

The information management server 100 produces provider information 111 based on the registered information, and stores the provider information 111 in the database 110. The provider information 111 contains a combination of the provider ID and the password, the name, the contact address, the genre of the provided information, a rule for calculation of an evaluation point, an evaluation point, and the like. The information evaluation agent 130 determines the rule for calculation of an evaluation point according to the genre of the provided information.

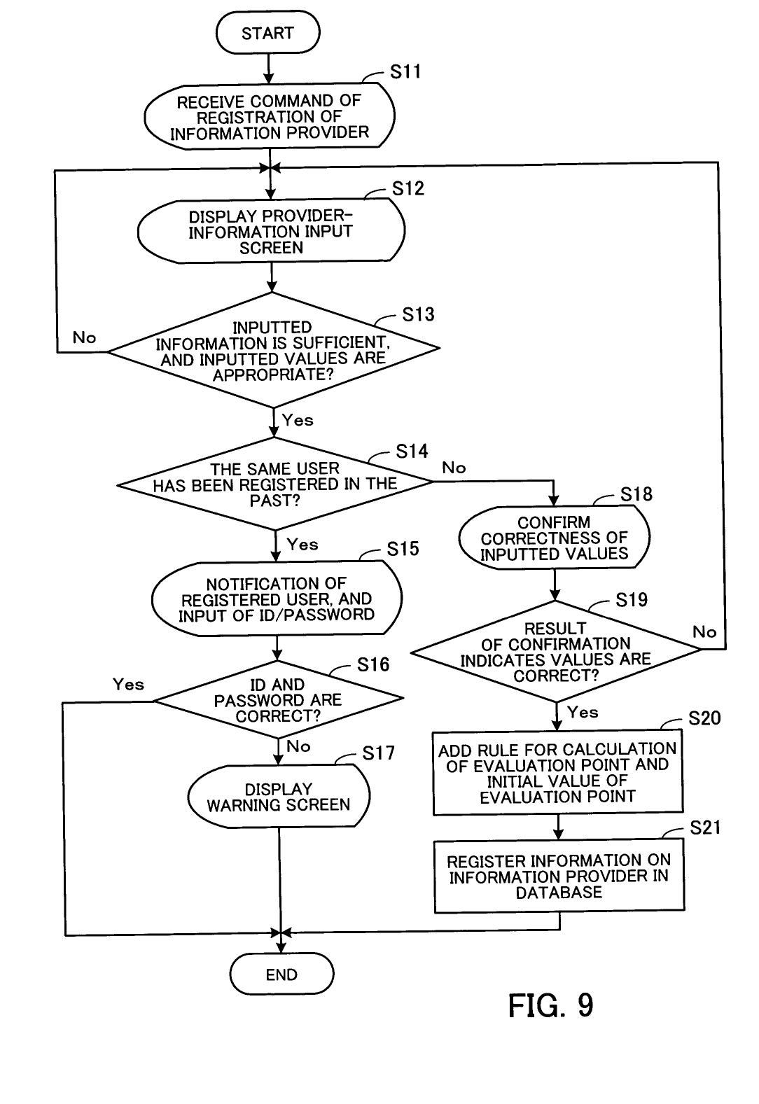

FIG. 9 is a flowchart indicating a sequence of processing for registration of an information provider. In the example of FIG. 9, information on the information provider is registered by access to a website. The processing sequence illustrated in FIG. 9 is explained below step by step.

[Step S11] When the provider terminal 210 accesses a predetermined webpage presented by the information management server 100, the information management server 100 sends to the provider terminal 210 image data for prompting the information provider to register information on the information provider. For example, when the provider terminal 210 accesses the information management server 100, a main screen is displayed on the provider terminal 210. The information provider 31 inputs a command “REGISTRATION OF INFORMATION PROVIDER” through a menu in the main screen. Thus, the information provider 31 can access a webpage for “INFORMATION-PROVIDER REGISTRATION.”

[Step S12] A provider-information input screen is displayed on the provider terminal 210. The provider-information input screen is a screen for inputting provider information such as the name of the provider, the contact address (including the postal address, the telephone number, and the mail address), and the genre of provided information.

[Step S13] The information provider 31 inputs information through the provider terminal 210. For example, the information provider 31 inputs provider information, and manipulates the provider terminal 210 so as to input a command “REGISTRATION.” Then, the inputted information is sent to the information management server 100, and the information management server 100 determines whether or not the inputted information is sufficient, and whether or not the inputted values are appropriate. When the inputted information is insufficient, or the inputted values are inappropriate, the operation goes to step S12, and the information provider 31 is requested to reinput the information. When the inputted information is sufficient, and the inputted values are appropriate, the operation goes to step S14.

[Step S14] The information management server 100 determines whether or not the same user has been registered in the past. When yes is determined, the operation goes to step S15. When no is determined, the operation goes to step S18.

[Step S15] The information management server 100 sends a notification of the registered user to the provider terminal 210. Then, a registered-user-notification screen is displayed on the provider terminal 210. In the registered-user-notification screen, the information provider 31 is requested to input the provider ID and the password.

[Step S16] When the information provider 31 inputs the provider ID and the password, the provider ID and the password are sent to the information management server 100. The information management server 100 determines whether or not the combination of the provider ID and the password is correct. When yes is determined, the processing of FIG. 9 is completed. When no is determined, the operation goes to step S17.

[Step S17] The information management server 100 sends data of a warning screen to the provider terminal 210. Then, the warning screen is displayed on the provider terminal 210. Thereafter, the processing of FIG. 9 is completed.

[Step S18] The information management server 100 sends the inputted values to the provider terminal 210. Then, a screen for confirmation of the inputted information is displayed on the provider terminal 210.

[Step S19] The information provider 31 sees the screen for confirmation displayed on the provider terminal 210, confirms whether or not the values are correct, and inputs a result of the confirmation in the provider terminal 210. The result of the confirmation is sent to the information management server 100. When the result of the confirmation indicates that the values are correct, the operation goes to step S20. When the result of the confirmation indicates that the values are incorrect, the operation goes to step S12 for reinput of the values.

[Step S20] The information management server 100 adds a rule for calculation of an evaluation point and an initial value of the evaluation point to the inputted provider information.

[Step S21] The information management server 100 registers the provider information 111 on the information provider in the database 110. When the registration is completed, the information management server 100 sends to the provider terminal 210 (which is used by the information provider 31) a notification of the completion of the registration. Thereafter, the processing of FIG. 9 is completed.

As explained above, at the time of registration of an information provider, the system automatically assigns an evaluation rule or evaluation function to the information provider. An evaluation rule set or evaluation function which has been prepared as standard by the system to which the present invention is applied may be used as the evaluation rule set or evaluation function assigned to the information provider. Alternatively, the system administrator can obtain the evaluation rule set or evaluation function assigned to the information provider, by modifying an existing rule set or evaluation function. In the case where a plurality of rule sets or evaluation functions are prepared, the information management server 100 notifies the system administrator of the information management server 100 of the existence of the plurality of rule sets or evaluation functions at the time of the registration of the information provider (by displaying a message on a screen of a terminal). When the system administrator manipulates the terminal so as to determine a rule set or an evaluation function which is to be associated with the information provider, the determined rule set or evaluation function is registered in the provider information 111. Thereafter, the information management server 100 sends to the provider terminal 210 a notification of the information added to the provider information 111.

Further, it is possible to modify the provider information which is registered as above, by using the provider terminal 210. The processing for modification of provider information is started at the time one of the information providers 31 to 34 chooses a command “MODIFICATION OF PROVIDER INFORMATION” in a menu screen, which is displayed when the information providers 31 to 34 access the information management server 100 through the provider terminals 210, 220, 230, and 240, and user authentication succeeds.

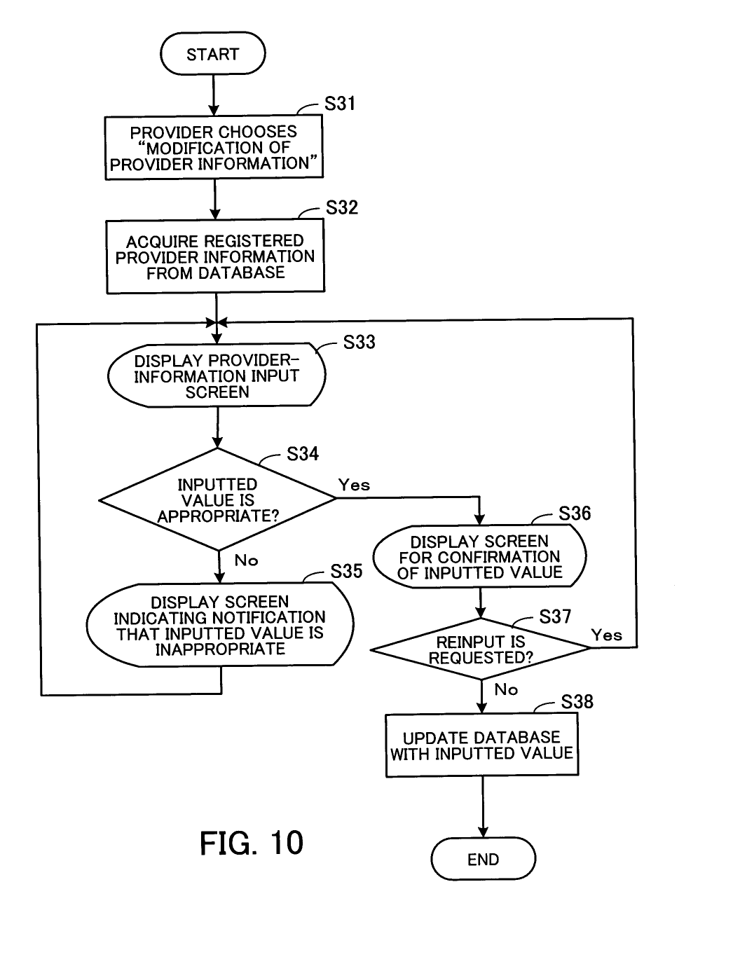

FIG. 10 is a flowchart indicating a sequence of processing for modifying provider information. The processing sequence illustrated in FIG. 10 is explained below step by step. In the following explanations, it is assumed that the information provider 31 modifies provider information by using the provider terminal 210.

[Step S31] The information provider 31 chooses a command “MODIFICATION OF PROVIDER INFORMATION” in a menu screen. Then, the chosen command is sent to the information management server 100.

[Step S32] The information management server 100 acquires registered provider information 111 from the database 110.

[Step S33] The information management server 100 sends the acquired provider information 111 to the provider terminal 210. Then, a provider-information input screen is displayed on the provider terminal 210. At this time, details of the provider information 111 which has been previously registered are displayed in the provider-information input screen.

[Step S34] The information provider 31 inputs a modified value in each item containing a value to be modified and being displayed in the screen of the provider terminal 210 (e.g., by rechoosing an option), and a command “MODIFICATION” into the provider terminal 210. Then, the provider terminal 210 sends the modified value to the information management server 100, and the information management server 100 determines whether or not the modified value is appropriate. When yes is determined, the operation goes to step S36. When no is determined, the operation goes to step S35.

[Step S35] The information management server 100 sends to the provider terminal 210 a notification that the inputted value is inappropriate. Then, the provider terminal 210 displays a message indicating the notification. Thereafter, the operation goes to step S33, and the provider terminal 210 prompts the information provider 31 to reinput an appropriate value.

[Step S36] The information management server 100 sends the inputted value to the provider terminal 210. Then, the provider terminal 210 displays a screen for confirmation of the inputted information.

[Step S37] The information provider 31 sees the screen for confirmation displayed on the provider terminal 210, confirms whether or not the displayed value is correct, and inputs a result of the confirmation in the provider terminal 210. The result of the confirmation is sent to the information management server 100. When the result of the confirmation indicates that the value is correct, the operation goes to step S38.

When the result of the confirmation indicates that the value is incorrect (i.e., when the information provider 31 designates reinput of the value), the operation goes to step S33 for reinput of the value. In this case, the provider-information input screen displayed in step S33 contains the value which has been inputted for modification.

[Step S38] The information management server 100 updates the provider information 111 in the database 110 with the value which has been inputted for modification. Thereafter, the information management server 100 sends to the provider terminal 210 a notification of completion of the modification. Details of the notification is displayed on the screen of the provider terminal 210.

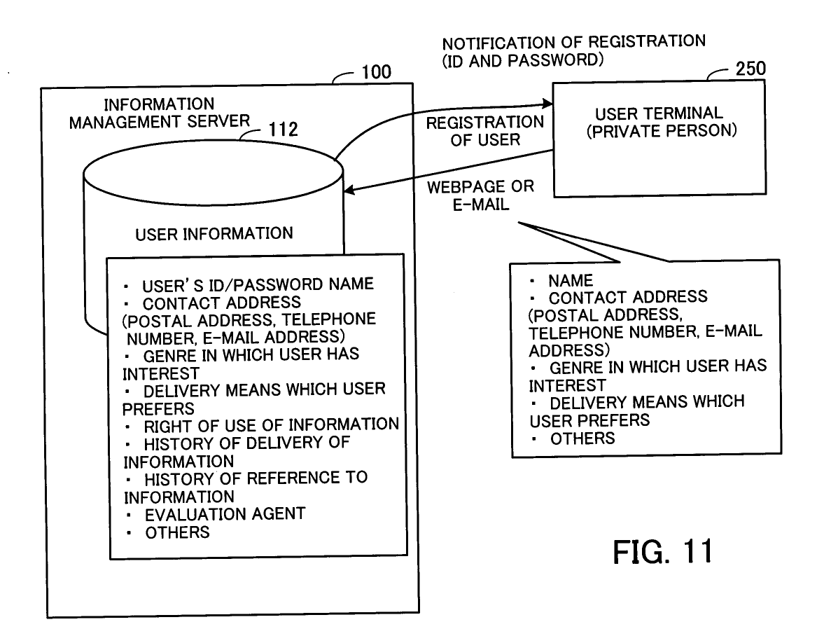

Next, a manner of registration of information on an information user is explained below. FIG. 11 is a conceptual diagram illustrating the manner of registration of information on an information user. In the example of FIG. 11, the information user 41 registers information on the information user 41 by using the user terminal 250.

The information user 41 accesses the information management server 100 by using the user terminal 250, and registers information on the information user 41 by using the user terminal 250. The registration can be realized by e-mail or access to a webpage which is presented by the information management server 100. The registered information contains the name of the provider, a contact address (including a postal address, a telephone number, and a mail address), a genre in which the information user has interest (an information group to which the provided information belongs), a delivery means which the information user 41 prefers, and the like. It is possible to use a different delivery means for each information group. When the information on the information user is registered, the information management server 100 issues a notification of registration to the user terminal 250, where the notification contains a user ID, a password, and the like.

The information management server 100 produces user information 112 based on the registered information, and stores the user information 112 in the database 110. The user information 112 contains a combination of the user ID and the password, the name, the contact address, the genre in which the information user has interest, the delivery means which the information user prefers, a right of use of information, a history of delivery of information, a history of reference to information, an information evaluation agent, and the like.

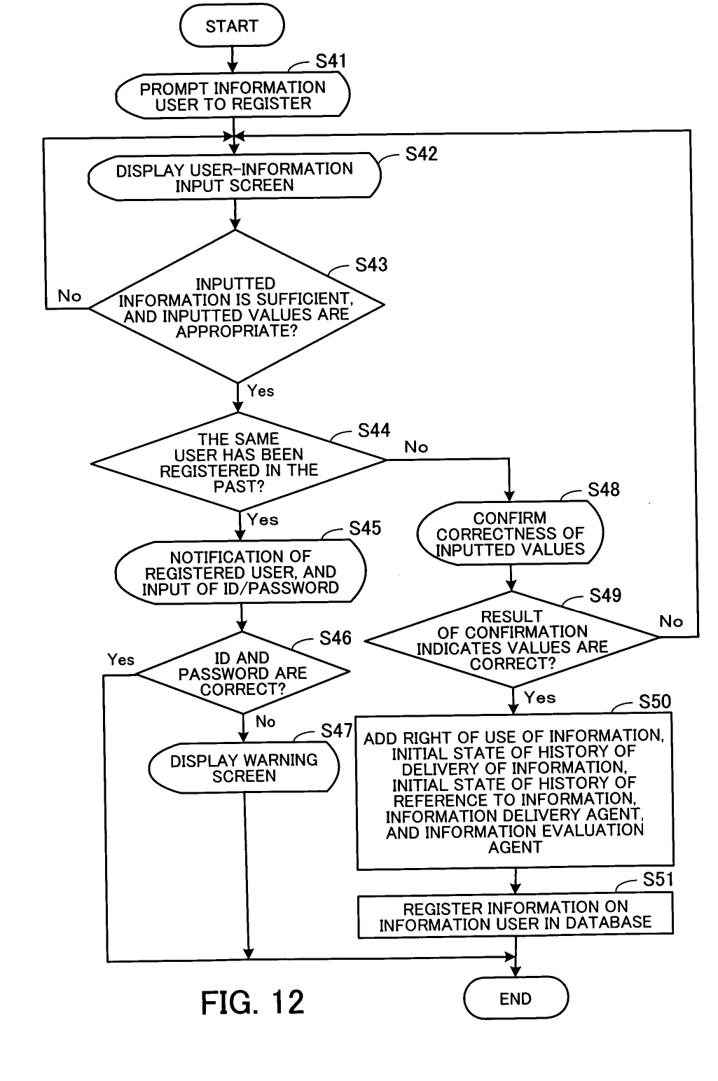

FIG. 12 is a flowchart indicating a sequence of processing for registration of an information user. In the example of FIG. 12, information on the information user is registered by access to a website. The processing sequence illustrated in FIG. 12 is explained below step by step.

[Step S41] When the user terminal 250 accesses a predetermined webpage presented by the information management server 100, the information management server 100 sends to the user terminal 250 image data for prompting the information user to register information on the information user. For example, when the user terminal 250 accesses the information management server 100, a main screen is displayed on the user terminal 250. The information user 41 inputs a command “REGISTRATION OF INFORMATION USER” through a menu in the main screen. Thus, the information user 41 can access a webpage for “REGISTRATION OF INFORMATION USER.”

[Step S42] A user-information input screen is displayed on the user terminal 250. The user-information input screen is a screen for inputting user information such as the name of the user, the contact address (including the postal address, the telephone number, and the mail address), the genre in which the information user has interest, the delivery means which the information user prefers, and the like.

[Step S43] The information user 41 inputs information through the user terminal 250. For example, the information user 41 inputs user information, and manipulates the user terminal 250 so as to input a command “REGISTRATION.” Then, the inputted information is sent to the information management server 100, and the information management server 100 determines whether or not the inputted information is sufficient, and whether or not the inputted values are appropriate. When the inputted information is insufficient, or the inputted values are inappropriate, the operation goes to step S42, and the information user is requested to reinput the information. When the inputted information is sufficient, and the inputted values are appropriate, the operation goes to step S44.

[Step S44] The information management server 100 determines whether or not the same user has been registered in the past. When yes is determined, the operation goes to step S45. When no is determined, the operation goes to step S48.

[Step S45] The information management server 100 sends a notification of the registered user to the user terminal 250, and a registered-user-notification screen is displayed on the user terminal 250. In the registered-user-notification screen, input of the user ID and the password is requested.

[Step S46] When the information user 41 inputs the user ID and the password, the user ID and the password are sent to the information management server 100. The information management server 100 determines whether or not the combination of the user ID and the password is correct. When yes is determined, the processing of FIG. 12 is completed. When no is determined, the operation goes to step S47.

[Step S47] The information management server 100 sends data of a warning screen to the user terminal 250. Then, the warning screen is displayed on the user terminal 250. Thereafter, the processing of FIG. 12 is completed.

[Step S48] The information management server 100 sends the inputted values to the user terminal 250. Then, a screen for confirmation of the inputted information is displayed on the user terminal 250.

[Step S49] The information user 41 sees the screen for confirmation displayed on the user terminal 250, confirms whether or not the values are correct, and inputs a result of the confirmation in the user terminal 250. The result of the confirmation is sent to the information management server 100. When the result of the confirmation indicates that the values are correct, the operation goes to step S50. When the result of the confirmation indicates that the values are incorrect, the operation goes to step S42 for reinput of the values.

[Step S50] The information management server 100 adds to the inputted user information a right of use of information, an initial state of a history of delivery of information, an initial state of a history of reference to information, an information delivery agent, and an information evaluation agent.

[Step S51] The information management server 100 registers the user information 112 on the information user in the database 110. When the registration is completed, the information management server 100 sends to the user terminal 250 (used by the information user 41) a notification of the completion of the registration. Thereafter, the processing of FIG. 12 is completed.

The information evaluation agent added in step S50 may be the information evaluation agent 130 which is prepared as standard by the information management server 100. Alternatively, it is possible to obtain the information evaluation agent added in step S50 by modifying the existing information evaluation agent 130.

In the case where a plurality of information evaluation agents are prepared, the information management server 100 may notify a system administrator of the information management server 100 of the existence of the plurality of information evaluation agents at the time of the registration of the information user. In this case, the system administrator can manipulate the terminal so as to determine one of the plurality of information evaluation agents which is to be associated with the information user. Then, the information management server 100 sends to the user terminal 250 a notification of the determined information evaluation agent.

Further, it is possible to modify the user information registered as above, by using the user terminal 250. The processing for modification of user information is started at the time one of the information users 41 to 43 chooses a command “MODIFICATION OF USER INFORMATION” in a menu screen, which is displayed when the information providers 31 to 34 and the information users 41 to 43 access the information management server 100 through the user terminals 250, 260, and 270, and user authentication succeeds.

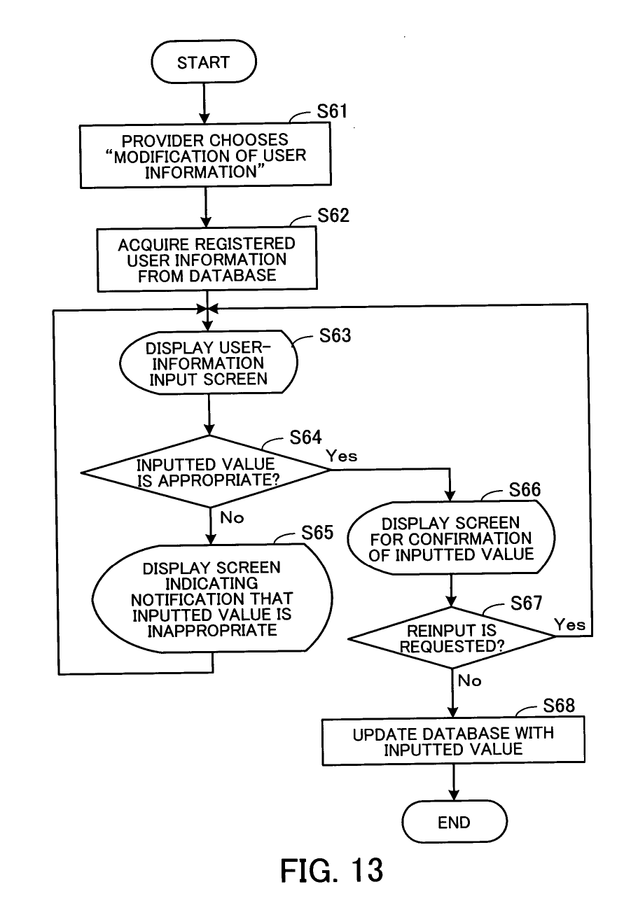

FIG. 13 is a flowchart indicating a sequence of processing for modifying user information. The processing sequence illustrated in FIG. 13 is explained below step by step. In the following explanations, it is assumed that the information user 41 modifies user information by using the user terminal 250.

[Step S61] The information user 41 chooses a command “MODIFICATION OF USER INFORMATION” in a menu screen. Then, the chosen command is sent to the information management server 100.

[Step S62] The information management server 100 acquires registered user information 112 from the database 110.

[Step S63] The information management server 100 sends the acquired user information 112 to the user terminal 250. Then, the user-information input screen is displayed on the user terminal 250. At this time, details of the user information 112 which has been previously registered are displayed in the user-information input screen.

[Step S64] The information user 41 inputs a modified value in an item containing a value to be modified and being displayed in the screen of the user terminal 250 (e.g., by rechoosing an option), and inputs a command “MODIFICATION” into the user terminal 250. Then, the user terminal 250 sends the modified value to the information management server 100, and the information management server 100 determines whether or not the modified value is appropriate. When yes is determined, the operation goes to step S66. When no is determined, the operation goes to step S65.

[Step S65] The information management server 100 sends to the user terminal 250 a notification that the inputted value is inappropriate. Then, the user terminal 250 displays a message indicating the notification. Thereafter, the operation goes to step S63, and the user terminal 250 prompts the information user 41 to reinput an appropriate value.

[Step S66] The information management server 100 sends the inputted value to the user terminal 250. Then, the user terminal 250 displays a screen for confirmation of the inputted information.

[Step S67] The information user 41 sees the screen for confirmation displayed on the user terminal 250, confirms whether or not the displayed value is correct, and inputs a result of the confirmation in the user terminal 250. The result of the confirmation is sent to the information management server 100. When the result of the confirmation indicates that the value is correct, the operation goes to step S68.

When the result of the confirmation indicates that the value is incorrect (i.e., when the information user 41 designates reinput of the value), the operation goes to step S63 for reinput of the value. In this case, the user-information input screen displayed in step S63 contains the value which has been inputted for modification.

[Step S68] The information management server 100 updates the user information 112 in the database 110 with the modified value. Thereafter, the information management server 100 sends to the user terminal 250 a notification of completion of the modification. Details of the notification is displayed on the screen of the user terminal 250.

Next, processing for registering information is explained below. The information providers 31 to 34 who have registered provider information on themselves can access the information management server 100 and provide information by using the provider terminals 210, 220, 230, and 240.

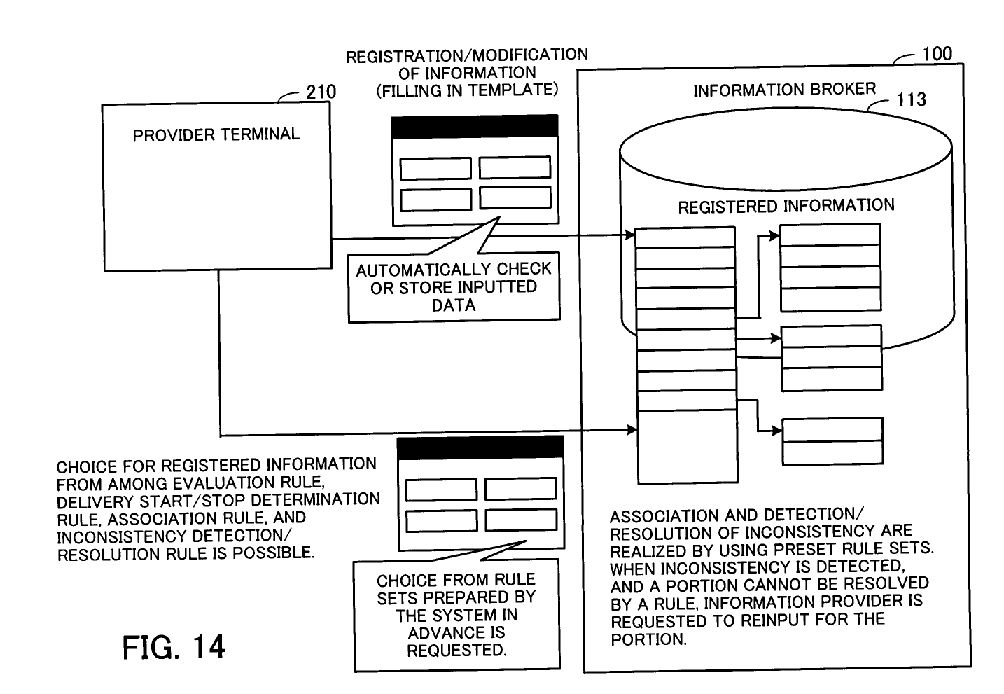

FIG. 14 is a conceptual diagram illustrating processing for registration of information. In the example of FIG. 14, the information provider 31 provides information by using the provider terminal 210.

The information provider 31 accesses the information management server 100, and makes registration or modification of information by using the provider terminal 210. At this time, it is possible to input information by using a template and filling in input items in the template, where the template is prepared in advance in the information management server 100. The information management server 100 automatically performs operations of data checking for correctness, data complement, and the like. For example, at the time of registration of information, operations of initializing the evaluation point and realizing association between registered information items are performed. In addition, when specified, operations of checking for inconsistency between the inputted information item and other information items in the same information group and resolving inconsistency are performed. When the inconsistency cannot be resolved by a rule for resolving inconsistency, a request for reinput of information is sent to the provider terminal 210.

Further, at the time of registration of information, a rule for evaluation of information and a rule for association can be set for each registered information item.

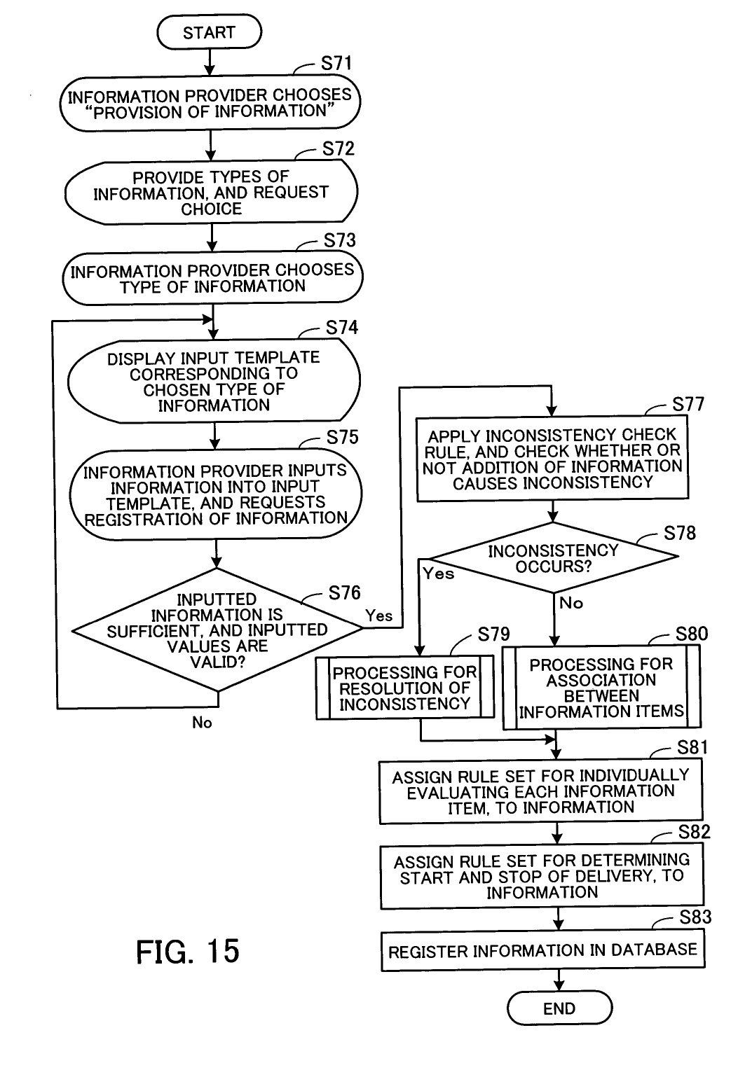

FIG. 15 is a flowchart indicating a sequence of the processing for registration of information. The processing sequence illustrated in FIG. 15 is explained below step by step. In the following explanations, it is assumed that the information provider 31 registers information by using the provider terminal 210.

[Step S71] After the information provider 31 accesses the information management server 100 by using the provider terminal 210, and user authentication succeeds, the information provider 31 chooses a command “PROVISION OF INFORMATION.” Then, the command “PROVISION OF INFORMATION” is sent to the information management server 100.

[Step S72] The information management server 100 sends information indicating types of information which the information provider 31 is allowed to provide. Then, the provider terminal 210 displays the types of information which the information provider 31 is allowed to provide, so that the provider terminal 210 can receive a choice from the displayed types.

[Step S73] The information provider 31 manipulates the provider terminal 210 so as to choose a type corresponding to the information which the information provider 31 wishes to provide, from the displayed types of information which the information provider 31 is allowed to provide. Then, the provider terminal 210 notifies the information management server 100 of the type of information chosen by the information provider 31.

[Step S74] The information management server 100 acquires an input template corresponding to the type of information chosen by the information provider 31, from input templates which are stored in advance in the database 110, and sends the acquired input template to the provider terminal 210. Then, the provider terminal 210 displays the input template corresponding to the type of information chosen by the information provider 31, so that the provider terminal 210 can receive input of information into input items provided in the input template.

[Step S75] The information provider 31 inputs information into the input template displayed on the provider terminal 210. When a plurality of templates exist, the information provider 31 manipulates the provider terminal 210 so as to choose one of the plurality of templates. Thereafter, the information provider 31 manipulates the provider terminal 210 so as to input a command to register information. Then, the provider terminal 210 sends the inputted information to the information management server 100.

[Step S76] When the information management server 100 receives the inputted information, the information management server 100 checks the inputted information for sufficiency of inputted items and validity of the values constituting the inputted information. When the inputted information is insufficient, or when a value constituting the inputted information is invalid, the operation goes to step S74, and the information provider 31 is prompted to reinput information. When the inputted information is sufficient, and the values constituting the inputted information are valid, the operation goes to step S77.

[Step S77] The information management server 100 checks whether or not registration of the inputted information causes inconsistency, by using a rule set for checking inconsistency between information items.

[Step S78] When the inputted information causes inconsistency, the operation of the information management server 100 goes to step S79. When the inputted information does not cause inconsistency, the operation of the information management server 100 goes to step S80.

[Step S79] The information management server 100 resolves the inconsistency between registered information items in accordance with a rule for resolving inconsistency. That is, the inconsistency is resolved by modification of previously registered information, request to the information provider for reinput of information, or the like, in accordance with a method specified in the rule. Thereafter, the operation goes to step S81.

[Step S80] The information management server 100 automatically sets association between information items by using a rule for association.

[Step S81] The information management server 100 assigns to a newly registered information item 113 a rule set for individually evaluating each information item.

[Step S82] The information management server 100 assigns to the newly registered information item 113 a rule set for determining a start and a stop of delivery and a rule set for determining a destination of delivery.

[Step S83] The information management server 100 stores the inputted information in the database 110 as the newly registered information item 113.

Thus, information can be registered in accordance with the processing sequence of FIG. 15.

For example, the checking for inconsistency between information items is performed as follows.

Inputted information items are each expressed in a tree structure which has a combination of an attribute name and an attribute value at each node. When a rule for detecting inconsistency is applied, the tree structure of a newly registered information item is compared with tree structures of already registered information items. An example of the rule for detecting inconsistency determines that inconsistency occurs, when there is an already registered information item having an identical tree structure to the newly registered information item and a node which corresponds to a node in the newly registered information item and has a different attribute value from the corresponding node in the newly registered information item. In addition, for example, inconsistency can be resolved by updating an attribute value at a node corresponding to a predetermined attribute name with an attribute value of the newly registered information item, or requesting an information provider to reinput an attribute value at a node at which the inconsistency occurs.

Association between information items are realized as follows.

When a rule for association between information items is applied, attributes of a newly registered information item and already registered information items are referred to. For example, a rule for association between information items sets a link for cross-reference between information items having an identical keyword.

An administrator of the information management server 100 prepares in advance a rule for individually evaluating each information item. In addition, one or more information providers who have a special power are each requested to register a rule for individually evaluating each information item at the time of registration of the information item. In the case where a rule for individually evaluating an information item has been registered at the time of registration of the information item, the registered rule for individually evaluating an information item is assigned to the information item. When no rule is arbitrarily assigned for individually evaluating an information item, a rule which is prepared in advance by the information management server 100 is assigned to the information item.

Each information item which has been registered can be arbitrarily modified by the information provider 31 who has registered the information item.

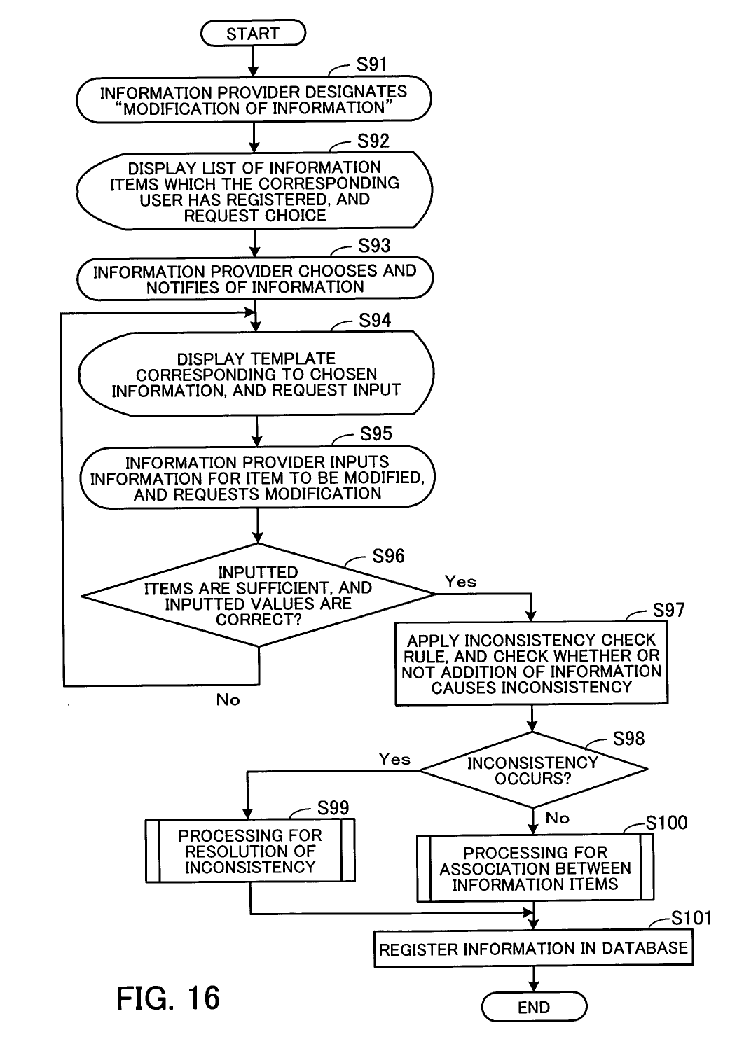

FIG. 16 is a flowchart indicating a sequence of processing for modification of registered information. The processing sequence illustrated in FIG. 16 is explained below step by step.

[Step S91] The processing for modification of registered information is started at the time the information provider 31 chooses a command “MODIFICATION OF INFORMATION” in a menu screen which is displayed when the information provider 31 accesses the information management server 100 through the provider terminal 210, and user authentication succeeds. Then, the command “MODIFICATION OF INFORMATION” is sent to the information management server 100.

[Step S92] The information management server 100 sends to the provider terminal 210 a list of information items 113 which have been registered in the past by the information provider 31. The provider terminal 210 displays the list of the information items 113 in order to receive a choice of one of the information items 113 which is to be modified.

[Step S93] The information provider 31 manipulates the provider terminal 210 so as to choose an information item which is to be modified, from among the information items 113 which have been registered in the past by the information provider 31. Then, the provider terminal 210 sends to the information management server 100 identification information identifying the chosen information item.

[Step S94] The information management server 100 acquires an input template corresponding to the chosen information item, from input templates which are stored in advance in the database 110, and sends the acquired input template to the provider terminal 210. Then, the provider terminal 210 displays the input template corresponding to the chosen information item, so that the provider terminal 210 can receive input of information into input items provided in the input template.

[Step S95] The information provider 31 inputs modified information into the input template displayed on the provider terminal 210. When the operation of inputting the modified information is completed, the information provider 31 manipulates the provider terminal 210 so as to input a command to modify the registered information item. Then, the provider terminal 210 sends the modified information to the information management server 100.

[Step S96] When the information management server 100 receives the inputted (modified) information, the information management server 100 checks the modified information for sufficiency of inputted items and validity of the values constituting the modified information. When the modified information is insufficient, or when a value constituting the modified information is invalid, the operation goes to step S94, and the information provider 31 is prompted to reinput information. When the modified information is sufficient, and the values constituting the modified information are valid, the operation goes to step S97.

[Step S97] The information management server 100 checks whether or not registration of the modified information causes inconsistency, by using a rule set for checking inconsistency between information items.

[Step S98] When the modified information causes inconsistency, the operation of the information management server 100 goes to step S99. When the modified information does not cause inconsistency, the operation of the information management server 100 goes to step S100.

[Step S99] The information management server 100 resolves the inconsistency between registered information items in accordance with a rule for resolving inconsistency. That is, the inconsistency is resolved by modification of previously registered information, request to the information provider for reinput of information, or the like, in accordance with a method specified in the rule. Thereafter, the operation goes to step S101.

[Step S100] The information management server 100 automatically sets association between information items by using a rule for association.

[Step S101] The information management server 100 updates the information item 113 registered in the database 110, with the modified information.

The checking of inconsistency between information items is performed as follows.

Inputted information items are each expressed in a tree structure which has a combination of an attribute name and an attribute value at each node. When a rule for detecting inconsistency is applied, the tree structure of the modified information item is compared with tree structures of already registered information items. For example, a rule for detecting inconsistency determines that inconsistency occurs, when there is an already registered information item having an identical tree structure to the modified information item and a node which corresponds to a node in the modified information item and has a different attribute value from the node in the modified information item. In addition, for example, inconsistency can be resolved by updating an attribute value at a node corresponding to a predetermined attribute name with the modified information item, or requesting an information provider to reinput an attribute value at a node at which the inconsistency occurs.

Next, processing for delivering information is explained below.

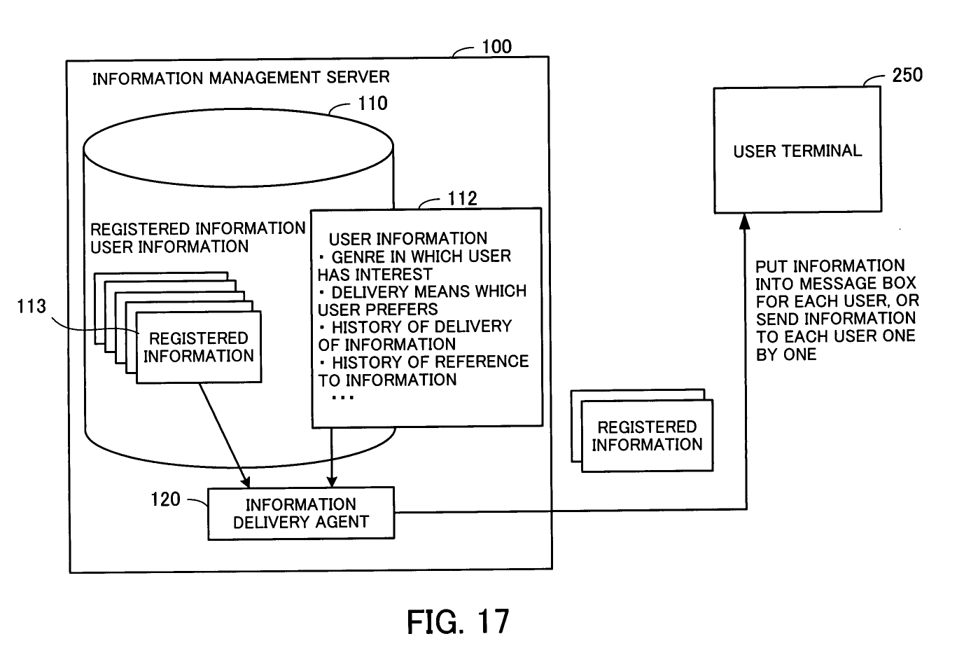

FIG. 17 is a conceptual diagram illustrating processing for delivery of information. The information delivery agent 120 delivers information by referring to the user information 112 and the registered information 113 stored in the database 110.

The information delivery agent 120 determines whether or not a registered information item 113 is to be delivered, based on a rule for determining a start of delivery and a rule for determining a stop of delivery. When the registered information item 113 is to be delivered, the information delivery agent 120 determines a candidate for a destination of the delivery based on a rule for determining a destination of delivery. Then, the information delivery agent 120 determines whether or not the registered information item 113 is to be delivered to the candidate for the destination, by referring to genres in which the information users have interest. Further, in the case where at least one information item is associated with a registered information item which is determined to be delivered as above, the information delivery agent 120 also determines whether or not the at least one information item is to be attached to the registered information item determined as above, by referring to at least one rule for determining a start of delivery, at least one rule for determining a stop of delivery, at least one rule for determining a destination of delivery, and information on the genres in which the information users have interest.

Each information item is delivered by a delivery means which is preferred and designated by each information user. For example, a delivery channel, a delivery schedule, whether or not the information item is delivered to the user terminals 250, 260, and 270, whether or not only a notification of existence of an information item to be delivered is sent, or the like can be designated.

When information to be delivered contains a binary large object (BLOB) such as data of a moving image, sound, or the like, the information delivery agent 120 chooses an appropriate delivery path according to the type of the information to be delivered.

When the destination is limited according to a delivery start condition and a delivery stop condition as described above, it is possible to suppress useless delivery of information. That is, delivery of information which does not satisfy the delivery start condition or information which satisfies the delivery stop condition is suppressed.

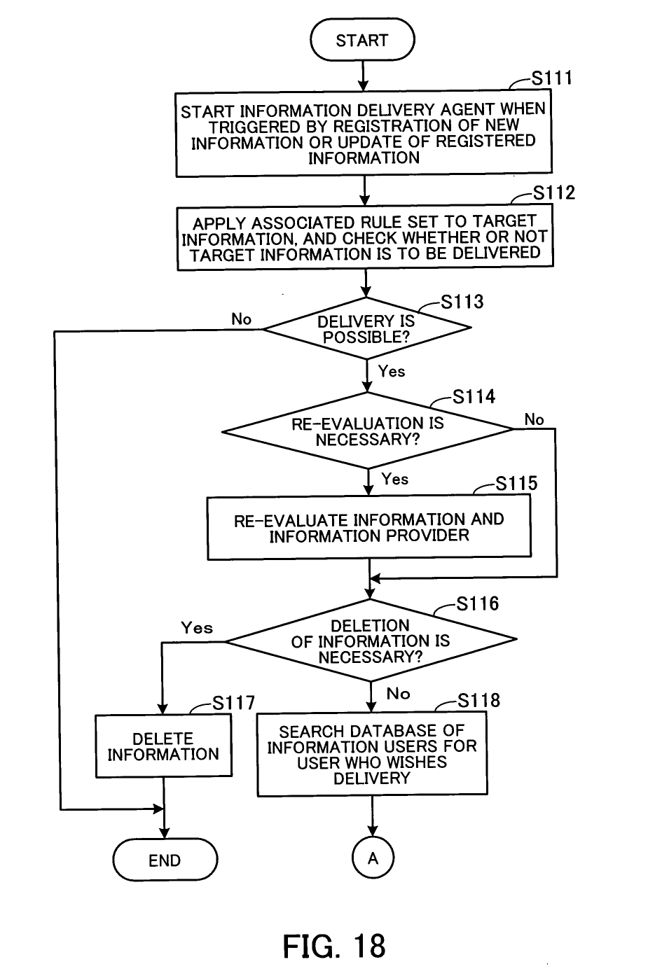

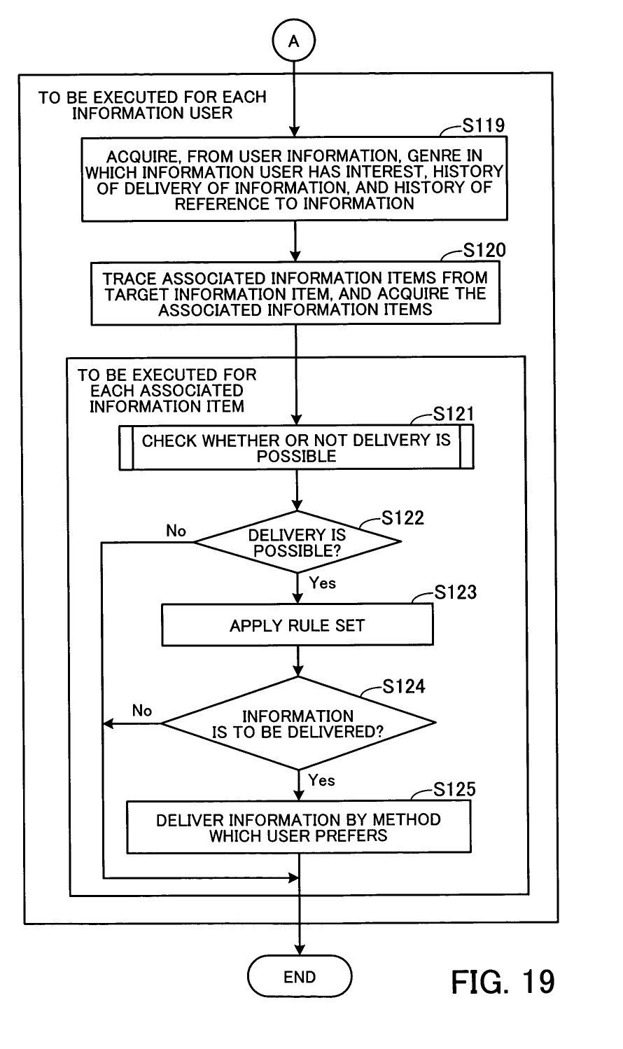

FIG. 18 is a flowchart indicating a first half of a sequence of processing for automatic delivery of information. The processing sequence illustrated in FIG. 18 is explained below step by step.

[Step S111] The information management server 100 activates the information delivery agent 120 when triggered by registration of a new information item or update of a registered information item. Thus, the processing for delivery of information is started.

[Step S112] The information delivery agent 120 checks whether or not a target information item (a newly registered information item or an information item which is registered and modified) is to be delivered, by applying to the target information item a rule set provided for determination of a start and a stop of delivery and associated with an information item. For example, when a time to deliver comes or before an availability period expires, an applicable rule for determination of a start and a stop of delivery determines that the target information item is to be delivered.

[Step S113] When the target information item does not satisfy a condition for allowing the delivery, the information delivery agent 120 does not deliver the target information item, and the processing for automatic delivery of information is completed. When the target information item satisfies the condition for allowing the delivery, the operation goes to step S114.

[Step S114] The information delivery agent 120 determines whether or not re-evaluation of an information group containing the target information item or an information provider of the target information item is necessary. For example, when an availability period of the target information item expires, the re-evaluation is necessary. When it is determined that the re-evaluation is necessary, the operation goes to step S115. When it is determined that the re-evaluation is unnecessary, the operation goes to step S116.

[Step S115] When re-evaluation of the information group containing the target information item or the information provider of the target information item is necessary, the information delivery agent 120 reevaluates the information item to be delivered and the information provider by using results of evaluations of the information item, a rule set for re-evaluation, or formulas.

[Step S116] The information delivery agent 120 determines whether or not deletion of the target information item is necessary. For example, when an availability period of the target information item expires, deletion of the target information item is necessary. When it is determined that deletion of the target information item is necessary, the operation goes to step S117. When it is determined that deletion of the target information item is unnecessary, the operation goes to step S118.

[Step S117] The information delivery agent 120 deletes the target information item, and the sequence of processing for automatic delivery of information is completed.

[Step S118] The information delivery agent 120 refers to the genre of the target information item, and searches through the registered information users for at least one user who wishes to receive delivery of at least one information item in the genre which the information delivery agent 120 refers to. Thereafter, the operation goes to step S119 in FIG. 19.

FIG. 19 is a flowchart indicating a second half of the sequence of processing for automatic delivery of information. The processing sequence illustrated in FIG. 19 is explained below step by step. The information delivery agent 120 performs the following processing for each information user searched for in step S118 in FIG. 18.

[Step S119] The information delivery agent 120 acquires from the user information 112 the genre in which the information user has interest, a history of delivery of information, and a history of reference to information.

[Step S120] The information delivery agent 120 acquires at least one information item which is associated with the target information item.

[Step S121] The information delivery agent 120 checks whether or not each of the at least one information item acquired in step S120 is to be delivered, by using a rule set for determination of a start and a stop of delivery.

[Step S122] The information delivery agent 120 selects at least one information item associated with the target information item and determined to be delivered, and the operation goes to step S123.

When an information item which is associated with the target information item is determined not to be delivered, no further processing is performed on the information item.

[Step S123] The information delivery agent 120 applies to each information item selected in step S122 a rule set for determining whether or not the information item is to be delivered to a destination, where the rule set is set for an information group to which the information item selected in step S122 belongs. That is, the information delivery agent 120 determines whether or not each information item selected in step S122 is to be delivered. For example, a rule determines that each information item selected in step S122 is to be delivered, when the information item selected in step S122 is in the genre in which the information user has interest, or when the number of times the information item selected in step S122 has been delivered or referred to in a predetermined period in the past (i.e., the frequency of delivery of or reference to the information item selected in step S122) is not less than a predetermined value.

[Step S124] When yes is determined in step S123, the operation goes to step S125. When no is determined in step S123, the sequence of processing for automatic delivery of information is completed.

[Step S125] The information delivery agent 120 delivers the target information item and the at least one information item which is selected in step S122 and determined to be delivered in step S123, by using a delivery means which is preferred by the information user. An example of the delivery means is e-mail, which is sent immediately or according to a predetermined schedule. In another example, the target information item and the information item which is selected in step S122 and determined to be delivered in step S123 are once stored in a message box which is provided on the server side for the information user, and a notification is sent to the information user.

Next, processing for evaluation of an information item is explained below.

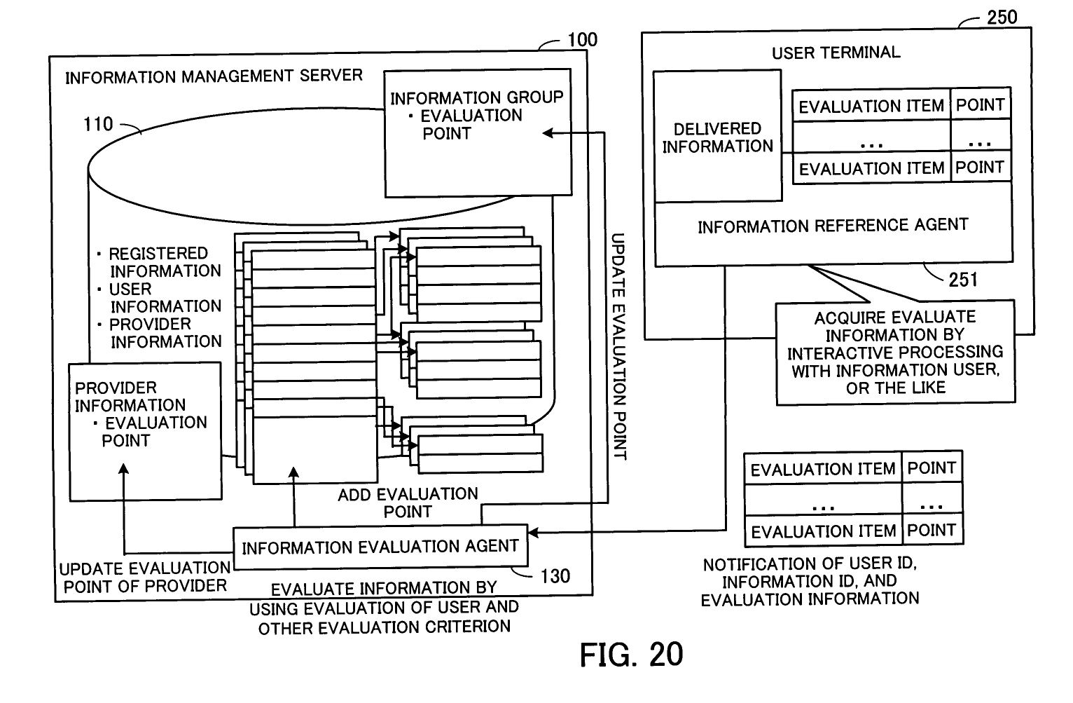

FIG. 20 is a conceptual diagram illustrating the processing for evaluation of an information item. The information evaluation agent 130 evaluates an information item by referring to the provider information 111, the user information 112, and the registered information 113, which are stored in the database 110. In the user terminal 250, the information reference agent 251 displays on the screen a delivered information item (which has been delivered from the information management server 100 in the past), and acquires an evaluation of the delivered information item from the information user 41. Then, the information reference agent 251 sends information on the acquired evaluation to the information management server 100.

Specifically, in response to a manipulation input by the information user 41, the information reference agent 251 displays the delivered information item and evaluation items for the delivered information item. When the information user 41 inputs evaluation points for the evaluation items into the user terminal 250, the information reference agent 251 produces evaluation information constituted by combinations of the evaluation items and the evaluation points based on the inputted evaluation points, and sends the evaluation information to the information management server 100. Then, the information evaluation agent 130 evaluates the registered information items 113. At this time, the information evaluation agent 130 calculates an evaluation based on the inputted information by using an evaluation function which is associated in advance. In the calculated evaluation, another evaluation point based on statistical data obtained from related information is also reflected as well as the evaluation point which is inputted by the information user 41 and subjective. Thus, the evaluation is made with higher reliability. In addition, according to the type of the evaluated information item, the information evaluation agent 130 may prompt the information user 41 to input an evaluation point again after a predetermined time elapses.

When an evaluation point of an information item is newly calculated, an evaluation point of the entire information group to which the evaluated information item belongs and an evaluation point of the information provider of the evaluated information item are also automatically recalculated based on the newly calculated evaluation point. When evaluation points calculated before the newly calculated evaluation point are high, the evaluation points of the information group and the information provider may become further higher.

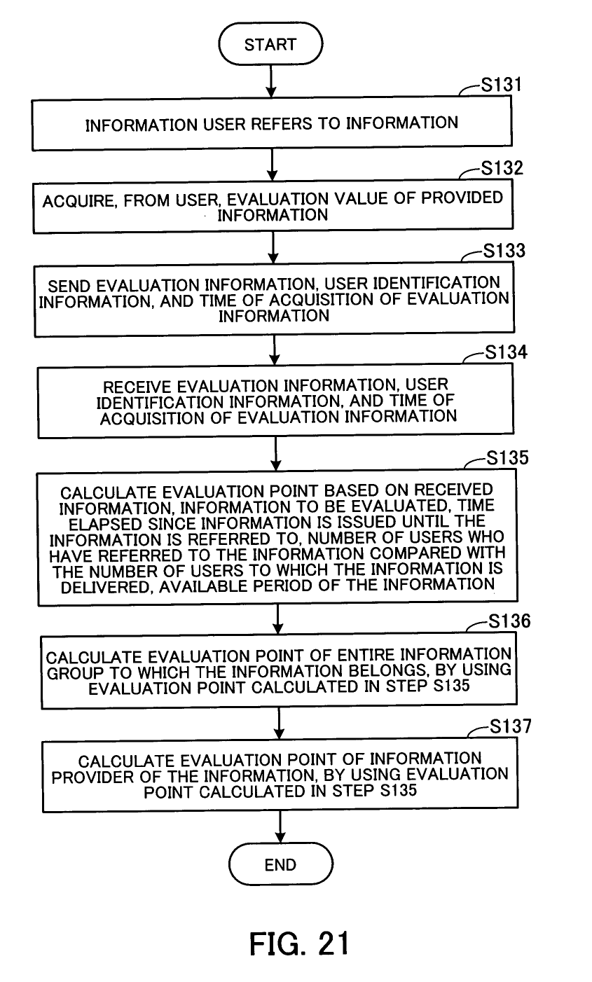

FIG. 21 is a flowchart indicating a sequence of processing for evaluation of an information item. The processing sequence of FIG. 21 is explained below step by step.

[Step S131] When the information user 41 manipulates the user terminal 250 so as to request reference to a delivered information item, the information reference agent 251 displays the delivered information item.

[Step S132] The information reference agent 251 acquires an evaluation value of the provided information item from the information user 41, where the evaluation value is given by the information user 41. For example, it is possible to acquire evaluation information by interactive processing with the information user 41. In addition, it is also possible to acquire evaluation information by an arbitrary manual input operation by the information user 41. The acquired evaluation information is a set of combinations of evaluation items and evaluation values.

[Step S133] The information reference agent 251 sends to the information management server 100 the evaluation information, information for identifying the information user 41 (user identification information), and a time at which the evaluation information is acquired (evaluation-information acquisition time).

[Step S134] The information evaluation agent 130 in the information management server 100 receives the evaluation information, the user identification information, and the evaluation-information acquisition time, which are sent from the user terminal 250.

[Step S135] The information evaluation agent 130 calculates an evaluation point. For example, the information evaluation agent 130 calculates the evaluation point of the target information item based on a time elapsed after issue of the target information item until reference to the target information item, the number of users who have referred to the target information item compared with the number of users to which the target information item is delivered, information indicating whether or not the availability period of the target information item has expired, and the information received in step S134. The evaluation value may be obtained by, for example, calculation of a weighted average, or ad hoc calculation using a rule set for calculation of an evaluation point.

[Step S136] The information evaluation agent 130 calculates an evaluation point of the entire genre (information group) including the target information item by using the evaluation point calculated in step S135. At this time, the evaluation point of the entire genre may be obtained by, for example, recalculation of an average value or a weighted average value of evaluation points, or ad hoc recalculation of an evaluation value using a rule set.

[Step S137] The information evaluation agent 130 calculates an evaluation point of the information provider of the information by using the evaluation point calculated in step S135. At this time, the evaluation point of the information provider may be obtained by, for example, recalculation of an average value or a weighted average value of evaluation points, or ad hoc recalculation of an evaluation value using a rule set.

When the availability period of the target information item expires before delivery of the target information item, a demerit point for expiration of the availability period of the target information item is obtained based on a predetermined constant, the number of references to the target information item, the rate or frequency of reference to the target information item, or the like. Then, the demerit point is subtracted from each of the evaluation value of the information genre including the target information item and the evaluation value of an issuer who issues the target information item. Alternatively, it is possible to calculate a discount rate in a similar manner to the demerit point, and multiply the evaluation value by the discount rate.

Next, a manner of newly producing an information group is explained. The administrator of the information management server 100 can arbitrarily produce an information group.

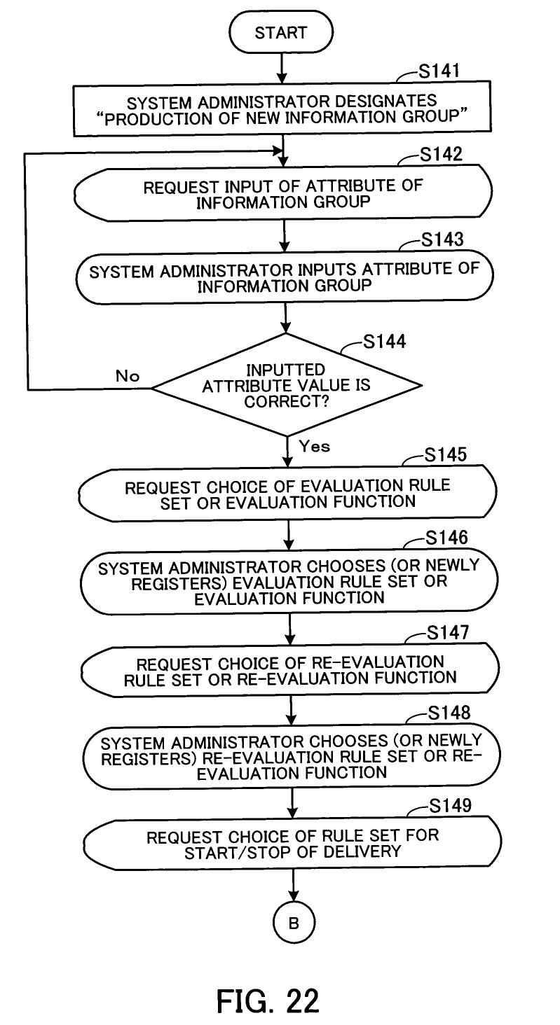

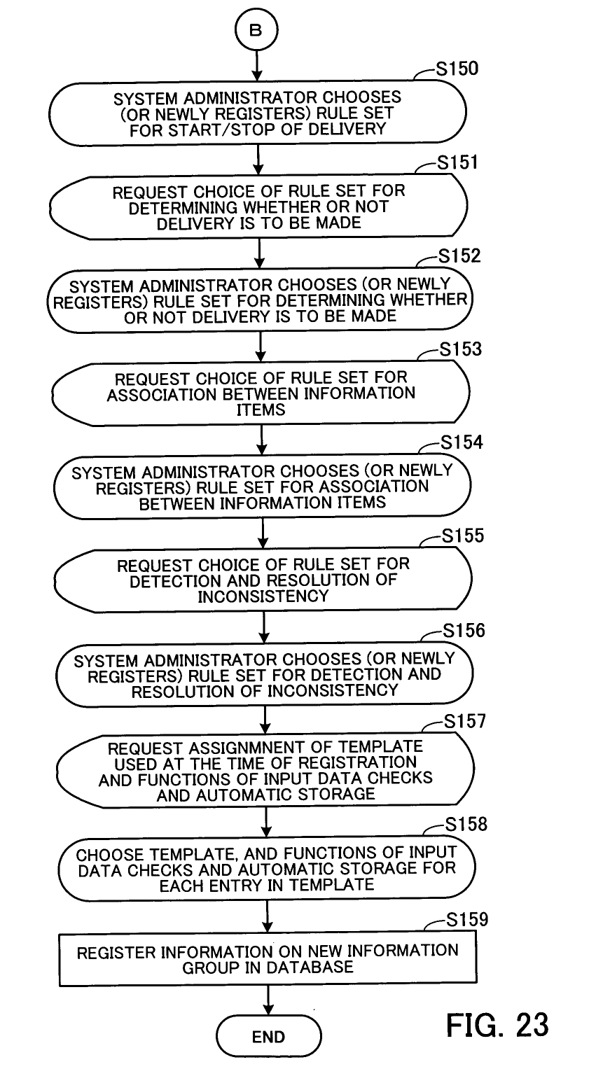

FIG. 22 is a flowchart indicating a first half of a sequence of processing for newly producing an information group. The processing sequence of FIG. 22 is explained below step by step.

[Step S141] When the information management server 100 receives a manipulation input of a command “Production of New Information Group” by a system administrator for which access authentication succeeded.

[Step S142] The information management server 100 requests the system administrator for input or choice of at least one value of at least one attribute (i.e., at least one attribute value) of an information group which is to be newly produced. Specifically, the information management server 100 displays a message for prompting the system administrator to input information on the at least one attribute of the information group, on a screen of a terminal of the system administrator. For example, the at least one attribute includes the name, a right of access, and the like.

[Step S143] The information management server 100 receives a manipulation input of the information on the at least one attribute of the information group.

[Step S144] When the system administrator inputs or chooses at least one attribute value of the information group which is to be newly produced, and manipulates the terminal of the system administrator so as to input a command “Start New Production,” the information management server 100 checks the at least one inputted attribute value for errors. When the at least one inputted attribute value is correct, the operation goes to step S145. When at least one attribute value has not yet been inputted or chosen, or when the at least one inputted attribute value is incorrect, the operation goes to step S142, and the system administrator is requested to reinput the at least one attribute value.

[Step S145] The information management server 100 defines a new information group having the inputted attribute value, and requests choice of a rule set or evaluation functions for evaluation of the information group in order to associate the rule set or evaluation functions with the newly produced information group. Specifically, the information management server 100 displays on the terminal of the system administrator a manipulation-input screen for inputting or choosing the rule set or evaluation functions for evaluation of the information group.

[Step S146] The information management server 100 receives a manipulation input indicating a choice of a rule set or evaluation functions which are provided for evaluation and are to be associated with the newly produced information group. Alternatively, at this time, the system administrator can newly produce a rule set or evaluation functions for evaluation of the information group, or add a rule set or evaluation functions which are prepared for evaluation of the information group by modification of an existing rule set or existing evaluation functions. Then, the newly produced or added rule set or evaluation functions are associated with the newly produced information group.

[Step S147] The information management server 100 requests the system administrator to choose a rule set or evaluation functions for re-evaluation, in order to associate the rule set or evaluation functions with the newly produced information group.

[Step S148] The information management server 100 receives a manipulation input indicating a choice of a rule set or evaluation functions which are provided for re-evaluation and are to be associated with the newly produced information group. Alternatively, at this time, the system administrator can newly produce a rule set or evaluation functions for re-evaluation of the information group, or add a rule set or evaluation functions which are prepared for re-evaluation of the information group by modification of an existing rule set or existing evaluation functions. Then, the newly produced or added rule set or evaluation functions are associated with the newly produced information group.

[Step S149] The information management server 100 requests the system administrator to choose a rule set for a start or a stop of delivery, in order to associate the rule set with the newly produced information group. Thereafter, the operation goes to step S150 in FIG. 23.

FIG. 23 is a flowchart indicating a second half of the sequence of processing for newly producing the information group. The processing sequence of FIG. 23 is explained below step by step.

[Step S150] The information management server 100 receives a manipulation input indicating a choice of a rule set which is provided for a start or a stop of delivery and is to be associated with the newly produced information group. Alternatively, at this time, the system administrator can newly produce a rule set for a start or a stop of delivery, or add a rule set which is prepared for a start or a stop of delivery by modification of an existing rule set. Then, the newly produced or added rule set is associated with the newly produced information group.

[Step S151] The information management server 100 requests the system administrator to choose a rule set for determining whether or not delivery to a destination is to be made, in order to associate the rule set with the newly produced information group.

[Step S152] The information management server 100 receives a manipulation input choosing the rule set which is provided for determining whether or not delivery to a destination is to be made, and is to be associated with the newly produced information group. Alternatively, at this time, the system administrator can newly produce the rule set for determining whether or not delivery to a destination is to be made, or add a rule set which is prepared for determining whether or not delivery to a destination is to be made, by modification of an existing rule set. Then, the newly produced or added rule set is associated with the newly produced information group.

[Step S153] The information management server 100 requests the system administrator to choose a rule set for association between information items, in order to associate the rule set with the newly produced information group.

[Step S154] The information management server 100 receives a manipulation input indicating a choice of a rule set which is provided for association between information items and is to be associated with the newly produced information group. Alternatively, at this time, the system administrator can newly produce a rule set for association between information items, or add a rule set which is prepared for association between information items by modification of an existing rule set. Then, the newly produced or added rule set is associated with the newly produced information group.

[Step S155] The information management server 100 requests the system administrator to choose a rule set for detection and resolution of inconsistency, in order to associate the rule set with the newly produced information group.

[Step S156] The information management server 100 receives a manipulation input indicating a choice of a rule set which is provided for detection and resolution of inconsistency and is to be associated with the newly produced information group. Alternatively, at this time, the system administrator can newly produce a rule set for detection and resolution of inconsistency, or add a rule set which is prepared for detection and resolution of inconsistency by modification of an existing rule set. Then, the newly produced or added rule set is associated with the newly produced information group.

[Step S157] The information management server 100 requests the system administrator to assign to the newly produced information group a template used at the time of registration and functions of input data checks and automatic data complement. At this time, a plurality of candidates for the template are displayed. In addition, when the system administrator selects each input item in the template, the information management server 100 displays a plurality of candidates for the functions of input data checks and automatic data complement, and requests the system administrator to make a choice.

[Step S158] The information management server 100 receives a manipulation input indicating a choice of the template and a choice of the functions of input data checks and automatic data complement for each input item in the template.

[Step S159] When the system administrator inputs a command “ASSOCIATION,” the information management server 100 associates information items designated for the newly produced information group, with the newly produced information group, and registers the newly produced information group in the database 110.

In addition, the above operations for setting the template and the rule set for association can be dispensed with in the case where initial values of the template and the rule set for association are set in the information management server 100.

As explained above, it is possible to classify provided information items into groups, and evaluate the information items in accordance with rules corresponding to the groups. Since appropriate evaluation rules corresponding to types of the information items can be adopted, it is possible to obtain reliable evaluation results.

Further, since the system administrator or the like can arbitrarily set the applicable rules, there is high flexibility in operations for change of the rules and the like.

[Examples of Services To Which the Present Embodiment Is Applied]

When the information management server according to the present embodiment is used, it is possible to provide various services through the Internet. Hereinbelow, examples of services to which the present embodiment is applied are explained.

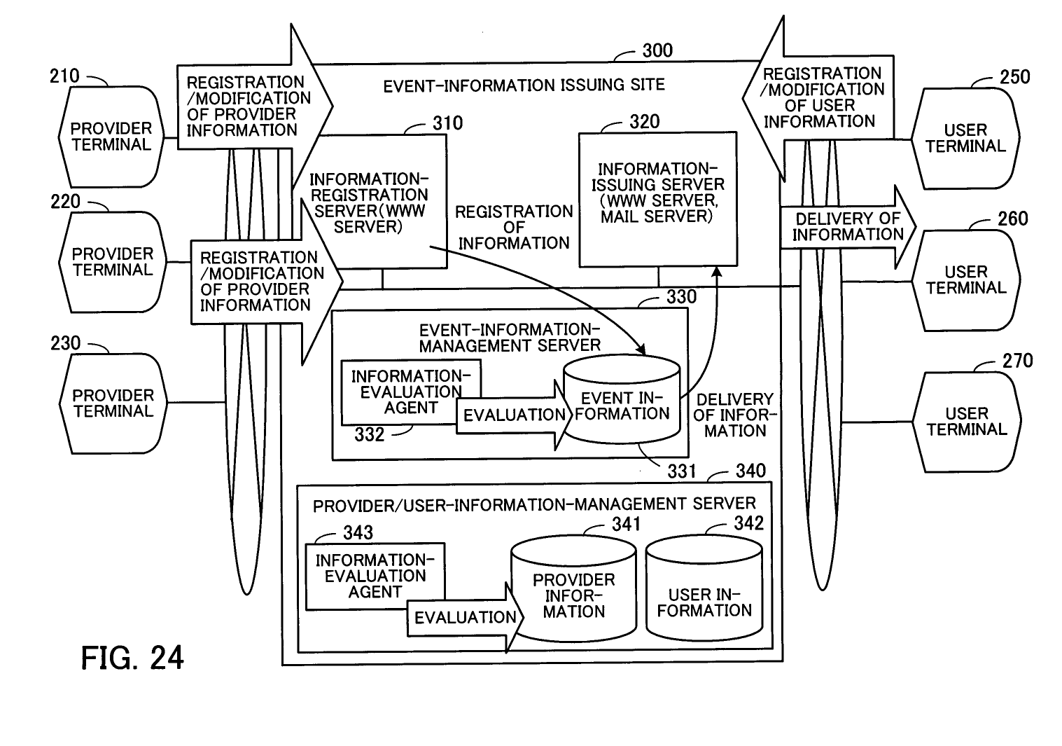

FIG. 24 is a diagram illustrating an example of application to an event-information issuing site. The event-information issuing site 300 is a website which introduces events (e.g., concerts, autograph sessions, or lecture meetings) held at various places. The event-information issuing site 300 receives from promoters or the like information on events to be held, and announces the information to the public. Then, the event-information issuing site 300 receives evaluations of the events from information users who have referred to the information and participated in the events, and publishes the results of the evaluations of the information on the events.

The event-information issuing site 300 comprises an information-registration server 310, an information-issuing server 320, an event-information-management server 330, and a provider/user-information management server 340. In the event-information-management server 330, event information 331 and an information-evaluation agent 332 are installed. In the provider/user-information management server 340, provider information 341, user information 342, and an information-evaluation agent 343 are installed.

The information-registration server 310 is, for example, a WWW (world wide web) server. The information-registration server 310 receives access through a network from the provider terminals 210, 220, and 230 used by the information providers 31, 32, and 33, and performs registration and modification of various information. For example, the information-registration server 310 receives requests for registration or modification of provider information from the provider terminals 210, 220, and 230, and performs registration of a new item of the provider information 341, modification of an already registered item of the provider information 341, or the like. In addition, the information-registration server 310 receives requests for registration or modification of event information from the provider terminals 210, 220, and 230, and performs registration of a new item of the event information 331, modification of an already registered item of the event information 331, or the like.

The information-issuing server 320 is, for example, a WWW server or a mail server. The information-issuing server 320 receives requests for registration or modification of user information from the user terminals 250, 260, and 270, and performs registration of a new item of the user information 342, modification of an already registered item of the user information 342, or the like. In addition, the information-issuing server 320 delivers event information to the user terminals 250, 260, and 270 used by information users. For example, when an item of the event information 331 on a classic concert is registered, the information-issuing server 320 detects at least one item of the user information of at least one user who chooses the classic music as a genre in which the at least one user has interest, from among the whole items of the user information 342, and delivers the item of the event information 331 of the classic concert to the at least one user.

Further, the information-issuing server 320 receives evaluations of items of the event information 331 from the user terminals 250, 260, and 270. For example, the information-issuing server 320 receives evaluations of a classic concert (for example, including the music performance level, quality of the music hall, appropriateness of the program, or the like) from users have attended the classic concert. When the information-issuing server 320 receives the evaluations, the information-issuing server 320 passes the received evaluations to the event-information-management server 330 and the provider/user-information management server 340.

The event-information-management server 330 manages the whole items of the event information 331. When the event-information-management server 330 receives the information users' evaluations of an item of the event information 331, the information-evaluation agent 332 in the event-information-management server 330 calculates an evaluation value of the evaluated item of the event information. The rule for calculation of the evaluation value is installed in advance according to an information group to which the item of the event information 331 belongs, or the like.

The event-information-management server 330 manages the provider information 341 and the user information 342. When the provider/user-information management server 340 receives from the information-issuing server 320 the information users' evaluations of an item of the event information 331, the information-evaluation agent 343 in the provider/user-information management server 340 calculates an evaluation value of an information provider who provides the evaluated item of the event information.

When the event-information issuing site 300 is constructed as above, it is possible to provide information on a specific field such as sports or hobby, and objectively evaluate the information. In this case, a system using the event-information issuing site 300 have the following features with respect to information providers, information users, characteristics of information items, registration and update of the information items, delivery of the information items, and evaluation of the information items.

(a) The information providers are members who have registered themselves in advance.

(b) The information users are members who have registered themselves in advance, or general users.

(c) Each item of the event information has an availability period. A condition for starting delivery can be set for each item of the event information. In addition, it is possible to use the degree of freshness in an evaluation criterion. The event information is required to be quickly delivered.

(d) The processing for registration or update of each item of the event information can be performed by input into a template. That is, the information providers are requested to input into a template a date and time (in the case where the time is determined), a place, a promoter, details, and remarks for each item of the event information. In addition, the date and time can be checked for consistency at the time of the input of the date and time. For example, it is possible to check whether or not a date and time in the past are inputted.

(e) When different events are inputted with identical date and time, place, and promoter, it is possible to determine that inconsistency occurs. In this case, the person who are inputting the information is inquired whether or not the inputted information is to be replaced.

(f) It is possible to designate a date and time at which an information item can be published, as a condition for allowing delivery.

(g) A portion of input items arranged in each template are compulsory, and the other portion of the input items are not compulsory.

(h) In the processing for delivery of information on an event, the information is delivered when a condition for starting the delivery is satisfied, and the event has not yet taken place.

(i) The destination of at least one information item on each event is an information user or users who have interest in the event. When each of the at least one information item is registered, the information item is delivered at earliest possible time.

(j) In the processing for evaluation of information on an event, each of the information-evaluation agent 332 and the information-evaluation agent 343 is started at an appropriate time after the event has taken place, and prompts each user to input an answer to a questionnaire. For example, the questionnaire may includes several items, and each questionnaire item may be an alternative question. The evaluation point is calculated based on the answers to the questionnaires, the manners in which the input items arranged in the information template are filled in, a time elapsed since the provision of the information on the event before the event takes place, and the like. In an example of a calculation formula for evaluation of the information on the event, a normalized, weighted average of the answers to the questionnaires, a filling ratio in the information template (indicating how detailed the inputted information is), and the reciprocal of the time elapsed since the provision of the information on the event before the event takes place (as an index which objectively indicates how quickly the information on the event is provided).

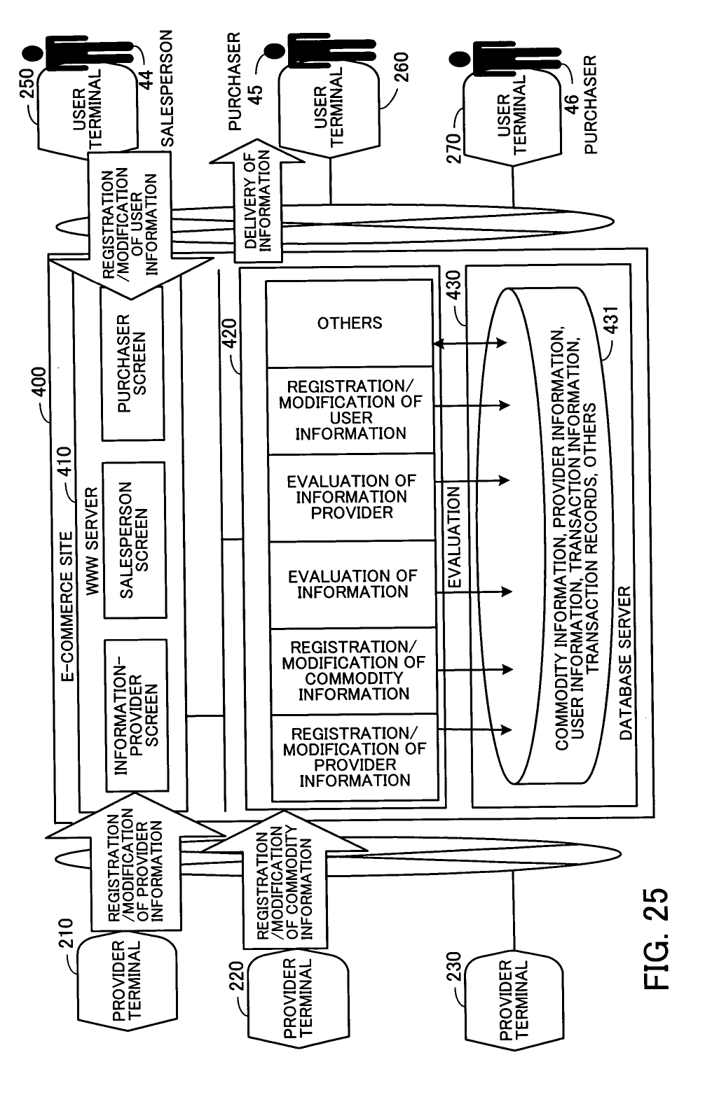

FIG. 25 is a diagram illustrating an example of an information-exchange service in an e-commerce site. When the present embodiment is applied to a community service in an e-commerce site, it is possible to refer to an evaluation of a transaction partner in an online transaction, and determine whether or not the transaction is to be performed.

The e-commerce site 400 comprises a WWW server 410, an application server 420, and a database server 430. The database server 430 has a database 431 which stores various information.

The WWW server 410 receives access through a network from the provider terminals 210, 220, and 230 used by the information providers 31 to 33, the user terminal 250 used by a salesperson 44, and the user terminals 260 and 270 used by purchasers 45 and 46, and transmits and receives information. For example, the WWW server 410 transmits screen data for information providers to the provider terminals 210, 220, and 230, and receives requests for registration or modification of provider information or commodity information from the provider terminals 210, 220, and 230. In addition, the WWW server 410 transmits screen data for the salesperson 44 to the user terminal 250, and receives requests for registration or modification of user information or evaluations of the commodity information from the user terminal 250. Further, the WWW server 410 transmits screen data for the purchasers 45 and 46 to the user terminals 260 and 270, and receives requests for registration or modification of user information or evaluations of the commodity information.

The WWW server 410 passes to the application server 420 the above requests and the information which are received from the provider terminals 210, 220, and 230 and the user terminals 250, 260, and 270, and requests the application server 420 to perform predetermined processing.

The application server 420 has various processing functions including functions of registration and modification of provider information, functions of registration and modification of commodity information, a function of evaluation of information, a function of evaluation of information providers, functions of registration and modification of user information, and the like. When the application server 420 receives various requests and information from the WWW server 410, the application server 420 activates necessary functions, and executes processing.

The database server 430 manages the database 431, which stores information such as commodity information, provider information, user information, transaction information, and transaction records.

Since the e-commerce site 400 has the above construction, it is possible to provide an intermember information-exchange service in an online shopping site or an intercompany transaction site. At this time, the e-commerce site 400 has the following features.

(a) The information providers are members who have registered themselves in advance, and are normally commodity purchasers or users.

(b) The information users are members who have registered themselves in advance, and are normally users who wish to have information for purchasing commodities.

(c) The registered information is review information on commodities or services. Therefore, in order to register commodity information, a template is filled with a commodity name and at least one index each of which indicates a degree of satisfaction corresponding to an attribute of the commodity. The condition for starting delivery is, for example, that the delivery is started after provision of a commodity or service is started, and the condition for stopping the delivery is, for example, that the delivery is stopped when the provision of a commodity or service ends. In this case, the information is not required to be quickly delivered.

(d) When a commodity or service is chosen in the processing for registration or modification of information, a template for inputting information on the commodity or service is displayed. An information provider inputs commodity information by filling in the template. When the values are inputted, the application server 420 checks for invalidness of the inputted values. For example, in inconsistency checking at the time of registration, it is determined that inconsistency occurs, when a different degree of satisfaction from the previous registration is designated by an identical information provider for at least one attribute of an identical commodity or service to the previous registration. In this case, the newest information replaces the older information, or the information provider is prompted to reconfirm only the different portion. This function is implemented as a rule set.

(e) In the processing for association between commodity information items, for example, when each commodity information item on a commodity or service of a type is newly registered, the newly registered commodity information item is associated with at least one other commodity information item on at least one commodity or service of the same type as the newly registered commodity information item. Further, in the case where there is at least one registered commodity information item on at least one commodity or service of at least one type which is related to the type of the commodity or service corresponding to the newly registered commodity information item, the at least one registered commodity information item may also be associated with the newly registered commodity information item. This function is implemented as a rule set.

(f) In the processing for delivering information, each information item on a commodity or service is not delivered after provision of the commodity or service ends. In such a delivery rule, a rule which performs control on a time axis is used. In addition, an administrator of the site can suppress delivery of information for a specific commodity or service for a predetermined period. This function is implemented as a rule set. In this case, quick delivery is not so strongly required.

(g) In the processing for evaluation of information, the evaluation is valid only when a commodity or service is actually purchased, in order to exclude evaluations based on incorrect information such as rumors and realize fair judgement. After each user who has perused an information item actually purchases a commodity or service at the site, an information evaluation agent in the client (in the user terminal) is activated, and receives input of evaluation items by information users (the salesperson 44 and purchasers 45 and 46). An information evaluation agent in the application server 420 calculates an evaluation point of the information item based on a value sent from the information evaluation agent in the client and the quality of the information item per se (e.g., a template filling ratio and an evaluation point of the information provider). When the evaluation point of the information item is calculated, the evaluation point of the information group and the evaluation point of the information provider are recalculated by using a rule set or evaluation functions provided for calculating the evaluation points of the information group and the information provider, respectively.

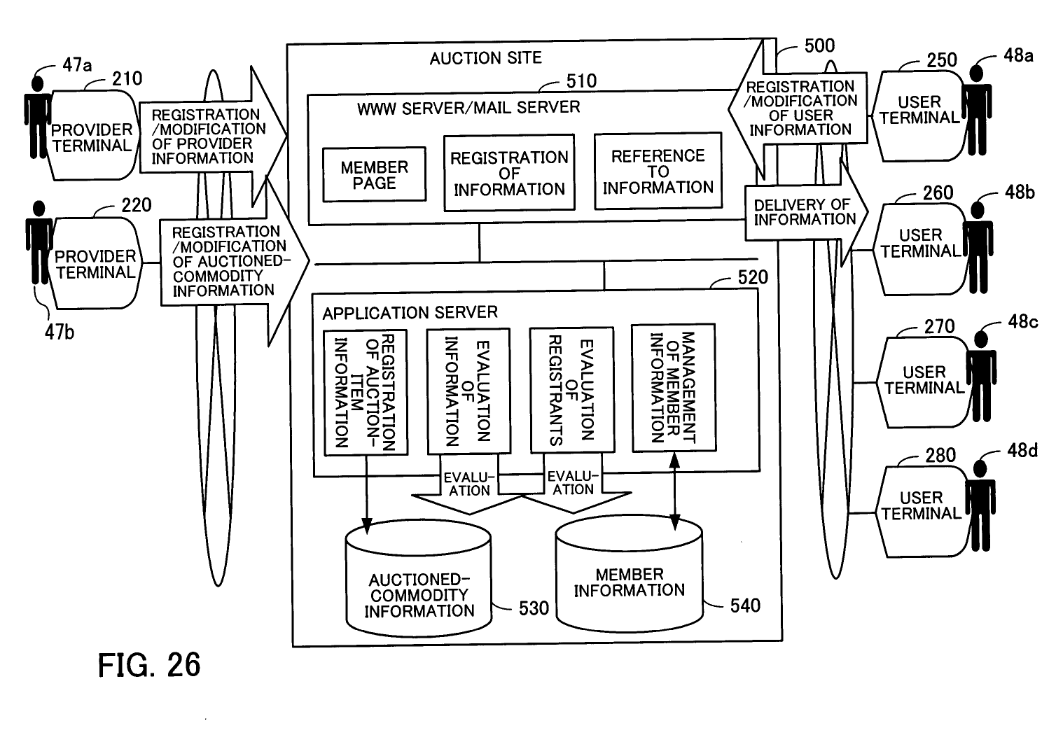

FIG. 26 is a diagram illustrating an example of a network auction service. In the example of FIG. 26, image data of still images and moving images are sold by an Internet auction. The auction site 500 comprises a WWW server/mail server 510, an application server 520, auctioned-commodity information 530, and member information 540.

The WWW server/mail server 510 receives access through a network from the provider terminals 210 and 220 used by members 47a to 47b who provide information items and the user terminals 250, 260, 270, and 280 used by members 48a to 48d who use the information items, and transmits and receives information. For example, the WWW server/mail server 510 transmits screen data of a member page to the provider terminals 210 and 220 and the user terminals 250, 260, 270, and 280. In addition, the WWW server/mail server 510 receives requests for registration or modification of provider information and requests for registration or modification of auctioned-commodity information from the provider terminals 210 and 220. Further, the WWW server/mail server 510 receives requests for registration or modification of user information and evaluations of commodity information. Furthermore, the WWW server/mail server 510 delivers auctioned-commodity information to the user terminals 250, 260, 270, and 280, and receives evaluations of the auctioned-commodity information from the user terminals 250, 260, 270, and 280.

The WWW server/mail server 510 passes to the application server 520 the requests and information received from the provider terminals 210 and 220 and the user terminals 250, 260, 270, and 280, and requests the application server 520 to perform predetermined processing.

The application server 520 has various processing functions including a function of registration of auction-item information, a function of evaluating information, a function of evaluating registrants, a function of managing member information, and the like. When the application server 520 receives various processing requests and information from the WWW server/mail server 510, the application server 520 activates necessary functions and performs processing. For example, when the application server 520 receives a request for registration of auctioned-commodity information, the application server 520 activates the function of registration of auction-item information, and stores a received information item as an item of the auctioned-commodity information item 530. In addition, when the application server 520 receives a request for registration of member information, the application server 520 activates the function of registration of member information, and stores a received information item as an item of the member information 540.

The auction site 500 constructed as above can provide an intermember information-exchange service in a site of an online shopping center, an online culture center, or the like. At this time, the auction site 500 has the following features.

(a) The information providers are registrants who have registered information or multimedia data (which includes, for example, data of still or moving images).

(b) The information users are purchasers of information or multimedia data (which includes, for example, data of still or moving images).

(c) It is unnecessary to specifically set an availability period of each auctioned-commodity information item 530. The registrants can delete registration of an information item for various reasons. The application server 520 also has functions for managing copyrights of the auctioned-commodity information 530 and preventing falsification of the auctioned-commodity information 530.

(d) In the processing for registration or update of information, it is unnecessary to check the information for inconsistency or resolve inconsistency in the information.

In the processing for association, for example, information items registered by an identical registrant are associated with each other. In addition, information items having similar colors or layouts may be associated with each other.

(e) In the processing for delivering information, it is sufficient to periodically issue notifications. At this time, it is possible to send thumbnails of information items with the notifications. The information items per se (which include, for example, data of still or moving images) are sent to members who have completed necessary procedures for purchasing the information items.

(f) It is possible to perform evaluation of information at the same time as the purchase of the information.

[Concrete Examples of Information Processing]

Concrete examples of delivery and evaluation of an information item provided by information providers are explained below.

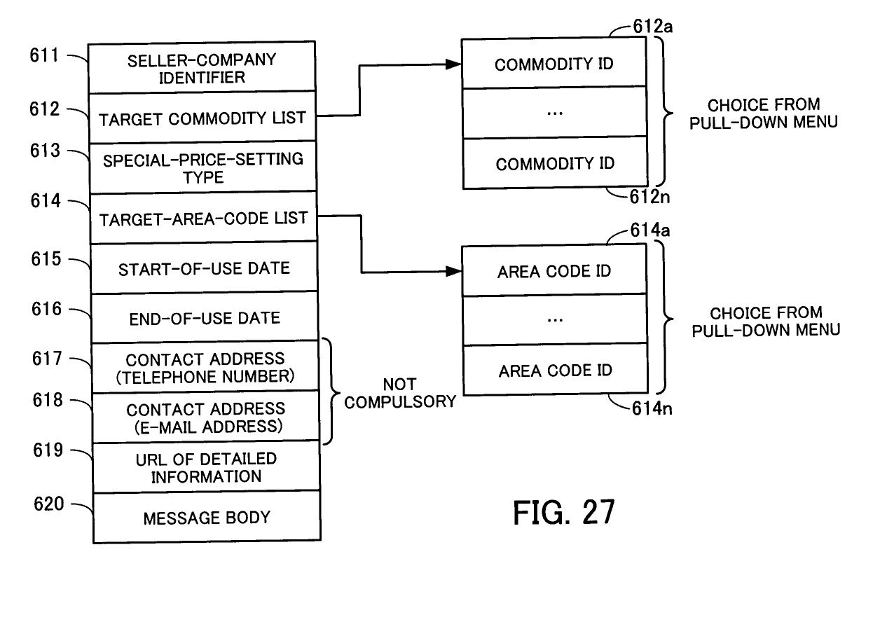

FIG. 27 is a diagram illustrating a concrete example of a registered information item. The registered information item illustrated in FIG. 27 is a campaign information item provided by a seller company to a purchaser company in an intercompany transaction. The campaign information item of FIG. 27 contains a seller-company identifier 611, a target commodity list 612, a special-price-setting type 613, a target-area-code list 614, a start-of-use date 615, an end-of-use date 616, a contact address (telephone number) 617, a contact address (e-mail address) 618, a URL (uniform resource locator) of detailed information 619, a message body 620, and the like, although the contact address (telephone number) 617, the contact address (e-mail address) 618, and the like can be dispensed with.

The target commodity list 612 is constituted by a plurality of commodity IDs 612a to 612n. For example, the target commodity list 612 is displayed in a pull-down menu, and one of the plurality of commodity IDs contained in the target commodity list 612 can be designated by choosing the commodity ID from the pull-down menu.

The target-area-code list 614 is constituted by a plurality of area codes 614a to 614n. For example, the target-area-code list 614 is displayed in a pull-down menu, and one of the plurality of area codes contained in the target commodity list 614 can be designated by choosing the area code from the pull-down menu.

When a campaign information item as above is registered in the information management server 100, the campaign information item can be provided. At this time, it is possible to set information groups classified by commodity category or seller company.

Each information item registered in the information management server 100 can be associated with other information items in accordance with a rule for association.

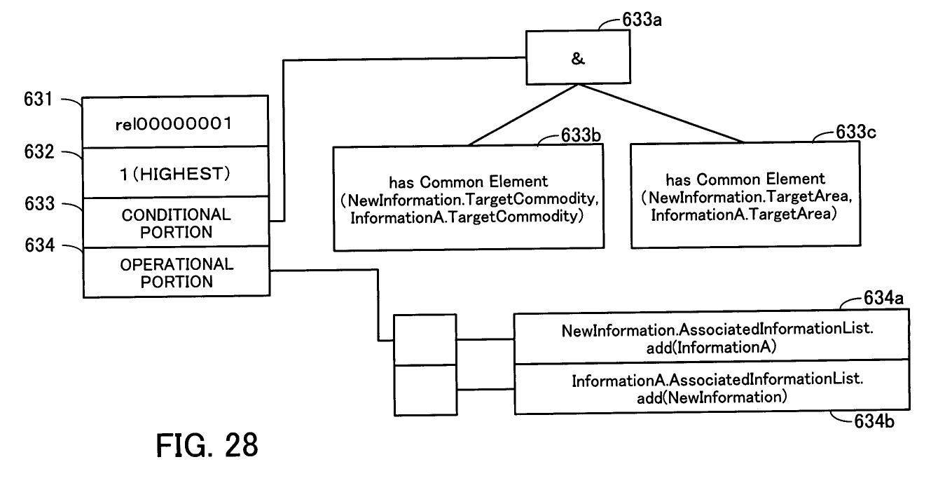

FIG. 28 is a diagram illustrating a concrete example of a rule for association between information items. In this example, when a new information item and another information item A have a common target commodity and a common target area (overlapping target areas), the information item A is added to information items associated with the new information item, and the new information item is added to information items associated with the information item A.

The rule for association is constituted by a rule ID 631, a priority 632, a conditional portion 633, and an operational portion 634. In the example of FIG. 28, the rule ID 631 is “re100000001,” and the priority 632 is the highest value “1 (HIGHEST).”

The conditional portion 633 defines a tree structure, which is constituted by a logical connector 633a and conditional nodes 633b and 633c. In the tree structure, the logical connector 633a corresponds to a root, and the conditional nodes 633b and 633c are subordinated to the logical connector 633a.

The logical product (&) is assigned to the logical connector 633a. A first condition,

hasCommonElement(NewInformation.TargetCommodity, InformationA.TargetCommodity),

is assigned to the conditional node 633b, where the result of the judgement based on the first condition becomes true in the case where the new information item and the information item A have a common target commodity. A second condition,

hasCommonElement(NewInformation.TargetArea, InformationA.TargetArea),

is assigned to the conditional node 633c, where the result of the judgement based on the second condition becomes true in the case where the new information item and the information item A have a common target area.

The operational portion 634 defines first and second execution functions 634a and 634b. The first execution function 634a is defined as

NewInformation.AssociatedInformationList.add (InformationA).

The first execution function 634a defines processing in which the information item A is added to an associated information list for the new information item. The second execution function 634b is defined as

InformationA.AssociatedInformationList.add (NewInformation).

The second execution function 634b defines processing in which the new information item is added to an associated information list for the information item A.

When a new information item is registered, a rule for association illustrated in FIG. 28 is applied, where each of information items which are already registered at that time is treated as the information item A in turn. Therefore, when each information item A satisfying the conditions defined in the conditional portion 633 is detected, the first and second execution functions 634a and 634b are executed, i.e., the new information item and the information item A are associated with each other.

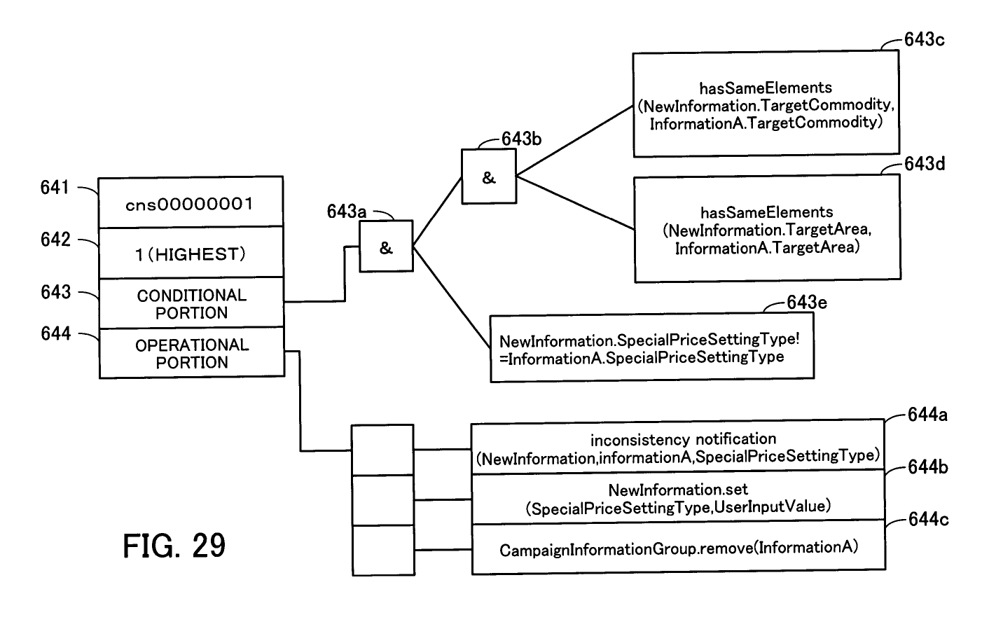

FIG. 29 is a diagram illustrating a concrete example of a rule for detection and resolution of inconsistency. In this example, when the new information item and the information item A have an identical target commodity, an identical target area, and different special-price-setting types, a person who inputs the new information item is notified of the inconsistency. At the time of the notification of the inconsistency, the person who inputs the new information item is requested to reinput the special-price-setting type, so that an information item having the reinputted special-price-setting type is reserved, and the older information item is deleted.

The rule for detection and resolution of inconsistency is constituted by a rule ID 641, a priority 642, a conditional portion 643, and an operational portion 644. In the example of FIG. 29, the rule ID 641 is “cns00000001,” and the priority 642 is the highest value “1 (HIGHEST).”

The conditional portion 643 defines a tree structure, which is constituted by logical connectors 643a and 643b and conditional nodes 643c, 643d, and 643e. In the tree structure, the logical connector 643a corresponds to a root, the logical connector 643b and the conditional node 643e are subordinated to the logical connector 643a, and the conditional nodes 643c and 643d are subordinated to the logical connector 643b.

The logical product (&) is assigned to each of the logical connectors 643a and 643b. A first condition,

hasSameElements(NewInformation.TargetCommodity, InformationA.TargetCommodity),

is assigned to the conditional node 643c, where the result of the judgement based on the first condition becomes true in the case where the target commodities of the new information item and the information item A are identical. A second condition,

hasSameElements(NewInformation.TargetArea, InformationA.TargetArea),

is assigned to the conditional node 643d, where the result of the judgement based on the second condition becomes true in the case where the target areas of the new information item and the information item A are identical. A third condition,

NewInformation.SpecialPriceSettingType !=InformationA.SpecialPriceSettingType,

is assigned to the conditional node 643e, where “!=” means “≠,” and the result of the judgement based on the third condition becomes true in the case where the special-price-setting types of the target commodities of the new information item and the information item A are different.

The operational portion 644 defines first, second, and third execution functions 644a, 644b, and 644c. The first execution function 644a is defined as

inconsistency notification(NewInformation, informations, SpecialPriceSettingType).

The first execution function 644a defines processing in which an inconsistency notification indicating that a special-price-setting type inconsistent with the information item A is inputted is sent to an information provider of the new information item.

The second execution function 644b is defined as

NewInformation.set(SpecialPriceSettingType, UserInputValue).

The second execution function 644b defines processing in which the value reinputted by the information provider (the user's input value) is set as the special-price-setting type of the new information item.

The third execution function 644c is defined as

CampaignInformationGroup.remove(InformationA).

The third execution function 644c defines processing in which the information item A in a campaign information group is removed.

When a new information item is registered, a rule for detection and resolution of inconsistency illustrated in FIG. 29 is applied, where each of information items which are already registered at that time is treated as the information item A in turn. Therefore, when an information item A satisfying the conditions defined in the conditional portion 643 is detected, the first to third execution functions 644a to 644c are executed. Therefore, when inconsistency occurs in the special-price-setting type, an information item having the reinputted special-price-setting type is reserved, and the older information item A is deleted.

As explained above, consistent information items are registered. Evaluation values for the registered information items are calculated based on a rule for evaluation of information at predetermined timings (e.g., when information users refer to the campaign information item).

In the case of campaign information, it is possible to use different methods for calculating evaluation values before and after a start of each campaign period. Hereinbelow, methods for calculating evaluation values before and after a start of a campaign period are explained.

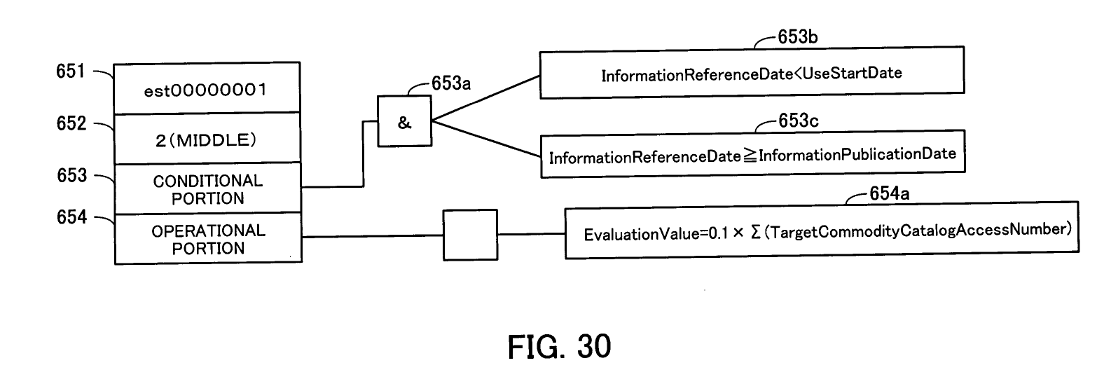

FIG. 30 is a diagram illustrating a rule for evaluating an information item before a start of a campaign period. In the example of FIG. 30, the number of accesses to a catalog (promotional information item) of each target commodity is used as an evaluation value before the start of the campaign period.

The rule for evaluation of an information item is constituted by a rule ID 651, a priority 652, a conditional portion 653, and an operational portion 654. In the example of FIG. 30, the rule ID 651 is “est00000001,” and the priority 652 is the second highest value “2 (MIDDLE).”

The conditional portion 653 defines a tree structure, which is constituted by a logical connector 653a and conditional nodes 653b and 653c. In the tree structure, the logical connector 653a corresponds to a root, and the conditional nodes 653b and 653c are subordinated to the logical connector 653a.

The logical product (&) is assigned to the logical connector 653a. A first condition,

InformationReferenceDate<UseStartDate,

is assigned to the conditional node 653b, where the result of the judgement based on the first condition becomes true in the case where a date at which the information item is referred to precedes a date at which use of the information item starts (i.e., a date at which the campaign period starts). A second condition,

InformationReferenceDate>InformationPublicationDate,

is assigned to the conditional node 653c, where the result of the judgement based on the second condition becomes true in the case where the date at which the information item is referred to equals or follows an information publication date (i.e., a date at which the campaign to be conducted is announced).

The operational portion 654 defines an execution function 654a. The execution function 654a is defined as

EvaluationValue=0.1×Σ(TargetCommodityCatalogAccessNumber),

where the variable “TargetCommodityCatalogAccessNumber” indicates the number of accesses to a catalog of a target commodity. The execution function 654a defines processing in which the evaluation value is set to 0.1 times the number of accesses to the catalog of the target commodity.

The above rule is applied at a predetermined time. Then, a value corresponding to the number of times the catalog of the target commodity has been accessed until that time is set as the evaluation value of the campaign information item. In the example of FIG. 30, the evaluation value of the campaign information item is 0.1 times the number of times the catalog of the target commodity has been accessed until the time the above rule is applied.

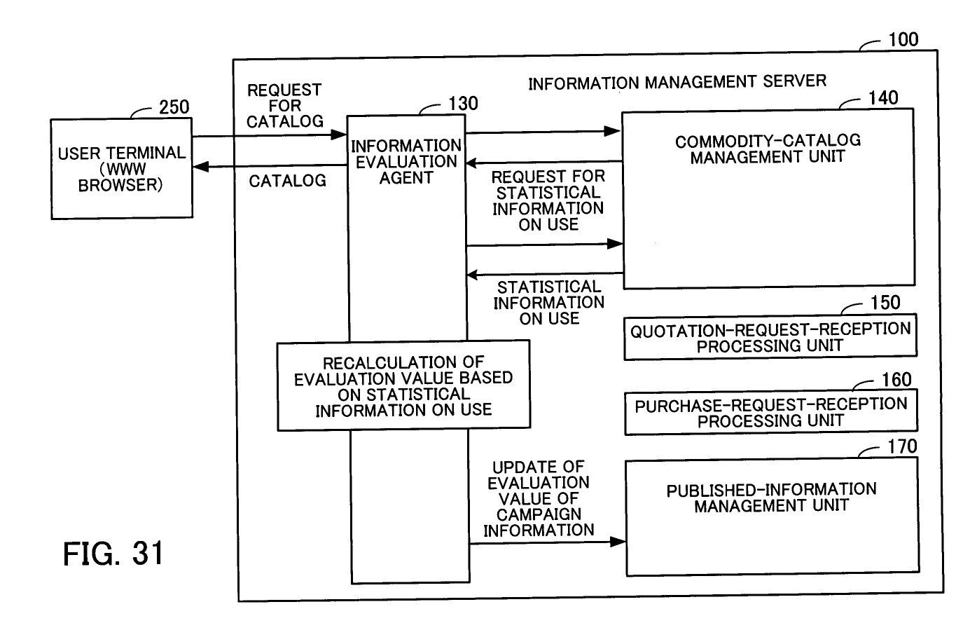

FIG. 31 is a diagram illustrating an example of an operation of an information-evaluation agent before the start of the campaign period. As illustrated in FIG. 31, in order to provide a service such as delivery of information for intercompany transaction, the information management server 100 comprises a commodity-catalog management unit 140, a quotation-request-reception processing unit 150, a purchase-request-reception processing unit 160, and a published-information management unit 170.

The commodity-catalog management unit 140 manages commodity-catalog information items, and delivers a commodity-catalog information item in response to a request from the user terminal 250. The quotation-request-reception processing unit 150 quotes the price of a commodity and the like in response to a request from the user terminal 250, and then sends the quotation to the user terminal 250. The purchase-request-reception processing unit 160 receives a request for purchase of a commodity from the user terminal 250. When the purchase-request-reception processing unit 160 receives a request for purchase, the purchase-request-reception processing unit 160 stores details of the request for purchase in a database. The published-information management unit 170 manages information items (such as campaign information items) to be published. When the published-information management unit 170 receives a request for reference to a published information item, the published-information management unit 170 sends the requested information item to the user terminal 250. The user terminal 250 accesses the information management server 100 through, for example, a web browser.

The information evaluation agent 130 monitors transmission of information between the user terminal 250 and other processing functions, and determines a time to evaluate information. When the time to evaluate information comes, the information is evaluated in accordance with a rule for evaluation.

In the case of FIG. 31, when a request for a catalog of a commodity (target commodity) is issued from the user terminal 250 before the start of the campaign period, the commodity-catalog management unit 140 sends information on the catalog of the commodity to the user terminal 250. Then, the information evaluation agent 130 requests statistics of use of the information on the catalog of the commodity from the commodity-catalog management unit 140. The commodity-catalog management unit 140 manages statistical information on use, and passes the statistical information on use to the information evaluation agent 130 in response to a request from the information evaluation agent 130, where the statistical information on use indicates the status of access to commodity-catalog information items, and includes the numbers of accesses.

The information evaluation agent 130 calculates (recalculates) an evaluation value based on the statistical information on use, which is received from the commodity-catalog management unit 140. Then, the information evaluation agent 130 sets the calculated evaluation value for a campaign information item corresponding to a campaign of a commodity which is listed in the commodity-catalog information item referred to. In the case of recalculation, the evaluation value which is already set is updated.

Thus, calculation of the evaluation value before the campaign period is realized.

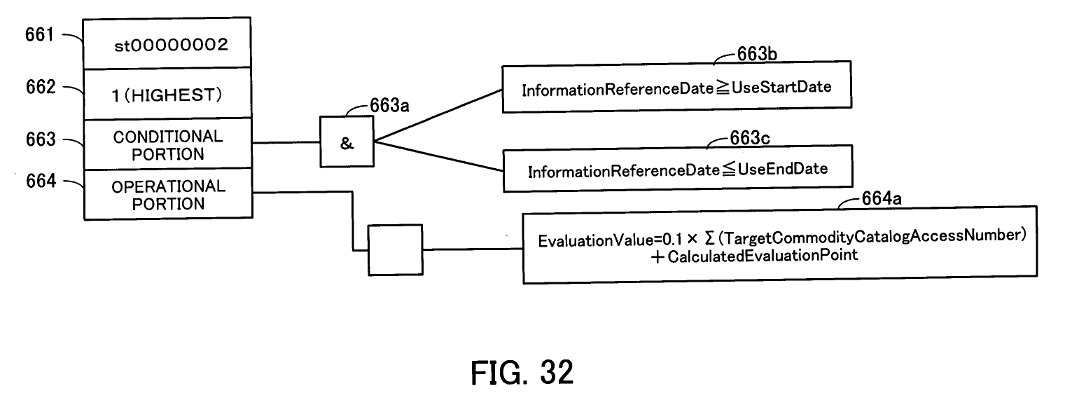

FIG. 32 is a diagram illustrating a rule for evaluating an information item during the campaign period. In the example of FIG. 32, the evaluation value during the campaign period is obtained by adding a calculation result reflecting whether or not each of operations of requesting a quotation, requesting a purchase, and cancelling a purchase is performed, to the number of accesses to the catalog of the target commodity.

The rule for evaluation of an information item is constituted by a rule ID 661, a priority 662, a conditional portion 663, and an operational portion 664. In the example of FIG. 32, the rule ID 661 is “est00000002,” and the priority 662 is the highest value “1 (HIGHEST).”

The conditional portion 663 defines a tree structure, which is constituted by a logical connector 663a and conditional nodes 663b and 663c. In the tree structure, the logical connector 663a corresponds to a root, and the conditional nodes 663b and 663c are subordinated to the logical connector 663a.

The logical product (&) is assigned to the logical connector 663a. A first condition,

InformationReferenceDate>UseStartDate,

is assigned to the conditional node 663b, where the result of the judgement based on the first condition becomes true in the case where a date at which the information item is referred to equals or follows a date at which use of the information item starts (i.e., a date at which the campaign period starts). A second condition,

InformationReferenceDate<UseEndDate,

is assigned to the conditional node 663c, where the result of the judgement based on the second condition becomes true in the case where a date at which the information item is referred to precedes or equals a date at which use of the information item ends (i.e., a date at which the campaign period ends).

The operational portion 664 defines an execution function 664a. The execution function 664a is defined as

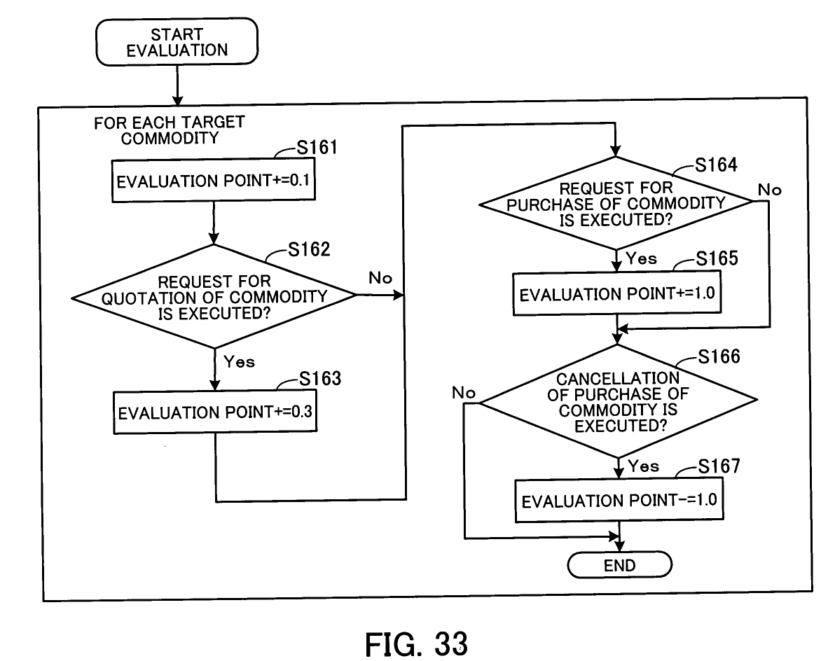

EvaluationValue=0.1×Σ(TargetCommodityCatalogAccessNumber)+CalculatedEvaluationPoint,

where the variable “TargetCommodityCatalogAccessNumber” indicates the number of accesses to a catalog of a target commodity, and the variable “CalculatedEvaluationPoint” indicates an evaluation point calculated in accordance with a predetermined procedure for calculation of an evaluation value. The execution function 664a defines processing in which a value calculated in accordance with the predetermined procedure for calculation of an evaluation value (which is realized by steps S162 to S167 in the processing sequence illustrated in FIG. 33) is added to 0.1 times the number of accesses to the catalog of the target commodity, and the added result is set as the evaluation value. In the predetermined procedure for calculation of an evaluation value, information reflecting whether or not each of operations of requesting a quotation, requesting a purchase, and cancelling a purchase is performed is used in the calculation.

FIG. 33 is a flowchart indicating a sequence of processing for calculation of an evaluation point when an information item is evaluated. The processing sequence of FIG. 33 is explained below step by step. The processing sequence of FIG. 33 is defined in the execution function 664a in FIG. 32, and executed by the information evaluation agent 130 (indicated in FIG. 3) in the information management server 100.

[Step S161] The information evaluation agent 130 adds 0.1 to an evaluation point of an information item so as to reflect the fact that the information item is referred to (accessed).

[Step S162] The information evaluation agent 130 determines whether or not a request for quotation of the corresponding commodity is executed in correspondence with the reference to the information item. When yes is determined, the operation goes to step S163. When no is determined, the operation goes to step S164.

[Step S163] The information evaluation agent 130 adds 0.3 to the evaluation point of the information item so as to reflect the fact that the request for quotation of the commodity is executed.

[Step S164] The information evaluation agent 130 determines whether or not a request for purchase of the corresponding commodity is executed in correspondence with the reference to the information item. When yes is determined, the operation goes to step S165. When no is determined, the operation goes to step S166.

[Step S165] The information evaluation agent 130 adds 1.0 to the evaluation point of the information item so as to reflect the fact that the request for purchase of the commodity is executed.

[Step S166] The information evaluation agent 130 determines whether or not cancellation of a purchase of the commodity is executed in correspondence with the reference to the information item. When yes is determined, the operation goes to step S167. When no is determined, the processing sequence of FIG. 33 is completed.

[Step S167] The information evaluation agent 130 subtracts 1.0 from the evaluation point of the information item so as to reflect the fact that cancellation of a purchase of the commodity is executed. Then, the processing sequence of FIG. 33 is completed.

As explained above, the evaluation point is increased when users issue a request for a quotation or purchase of a target commodity, and decreased when the users cancel a purchase of the target commodity. The above processing is repeatedly performed for each commodity-information item.

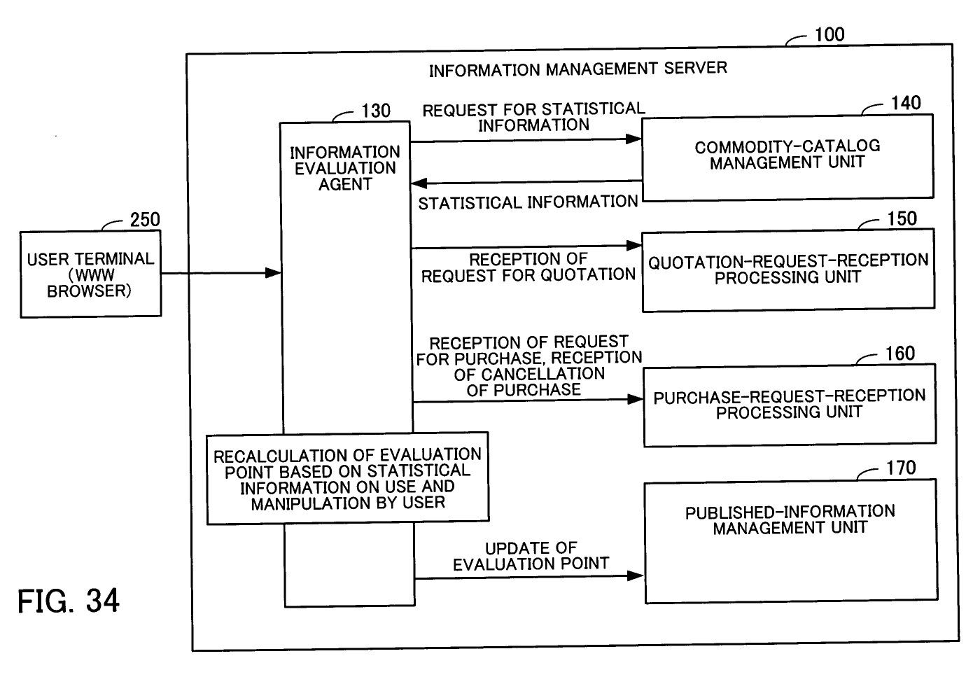

FIG. 34 is a diagram illustrating an example of an operation of the information-evaluation agent during a campaign period. When the user terminal 250 refers to a catalog of a commodity during a campaign period, the information evaluation agent 130 outputs a request for statistical information to the commodity-catalog management unit 140. Then, the commodity-catalog management unit 140 passes the statistical information to the information evaluation agent 130. Thereafter, when the user terminal 250 requests a quotation, the quotation-request-reception processing unit 150 prepares a quotation, and sends information on the quotation to the user terminal 250. In addition, when the user terminal 250 requests a purchase, the purchase-request-reception processing unit 160 receives the request for the purchase, and stores details of the received order in a database. When the user terminal 250 requests cancellation of a purchase, the purchase-request-reception processing unit 160 receives the request for the cancellation of the purchase, and cancels details of corresponding order stored in the database.

The information evaluation agent 130 monitors the above of operations, and calculates (or recalculates) an evaluation point corresponding to the statistical information and operations by a user. The calculated evaluation point is passed to the published-information management unit 170, and set as an evaluation value of a campaign information item (or the evaluation value of the campaign information item is updated with the calculated evaluation point).

Next, a rule for re-evaluation of an information group is explained below.

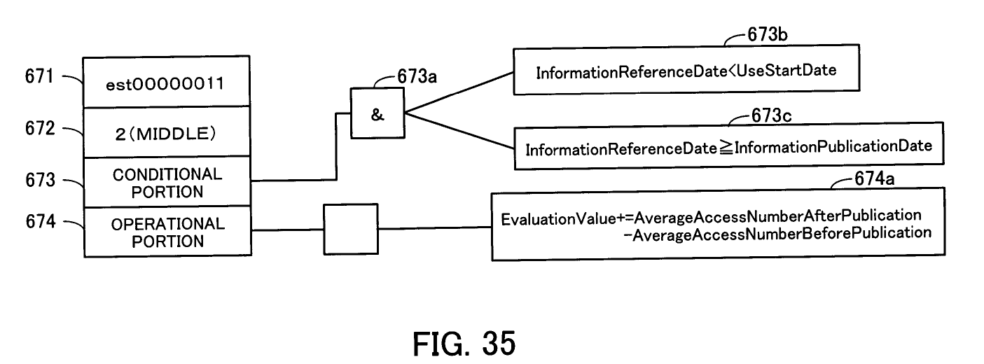

FIG. 35 is a diagram illustrating an example of a rule for re-evaluation of an information group before a start of a campaign period. In this example, an average number of accesses to a catalog of a target commodity is reflected in an evaluation value before a start of a campaign period.

The rule for re-evaluation of an information group is constituted by a rule ID 671, a priority 672, a conditional portion 673, and an operational portion 674. In the example of FIG. 35, the rule ID 671 is “est00000011,” and the priority 672 is the second highest value “2 (MIDDLE).”

The conditional portion 673 defines a tree structure, which is constituted by a logical connector 673a and conditional nodes 673b and 673c. In the tree structure, the logical connector 673a corresponds to a root, and the conditional nodes 673b and 673c are subordinated to the logical connector 673a.

The logical product (&) is assigned to the logical connector 673a. A first condition,

InformationReferenceDate<UseStartDate,

is assigned to the conditional node 673b, where the result of the judgement based on the first condition becomes true in the case where a date at which the information item is referred to precedes a date at which use of the information item starts (i.e., a date at which the campaign period starts). A second condition,

InformationReferenceDate>InformationPublicationDate,

is assigned to the conditional node 673c, where the result of the judgement based on the second condition becomes true in the case where the date at which the information item is referred to equals or follows an information publication date (i.e., a date at which the campaign to be conducted is announced).

The operational portion 674 defines an execution function 674a. The execution function 674a is defined as

EvaluationValue +=AverageAccessNumberAfterPublication −AverageAccessNumberBeforePublication,

where “+=” is an assignment operator which means that a sum of the values on the right and left sides of the assignment operator is assigned to the variable on the left side, the variable “AverageAccessNumberAfterPublication” indicates an average number of accesses to the catalog of the target commodity after the publication date, and the variable “AverageAccessNumberBeforePublication” indicates an average number of accesses to the catalog of the target commodity before the publication date. The execution function 674a defines processing in which the difference in the average number of accesses to the catalog of the target commodity before and after the information publication date is reflected in the evaluation value.

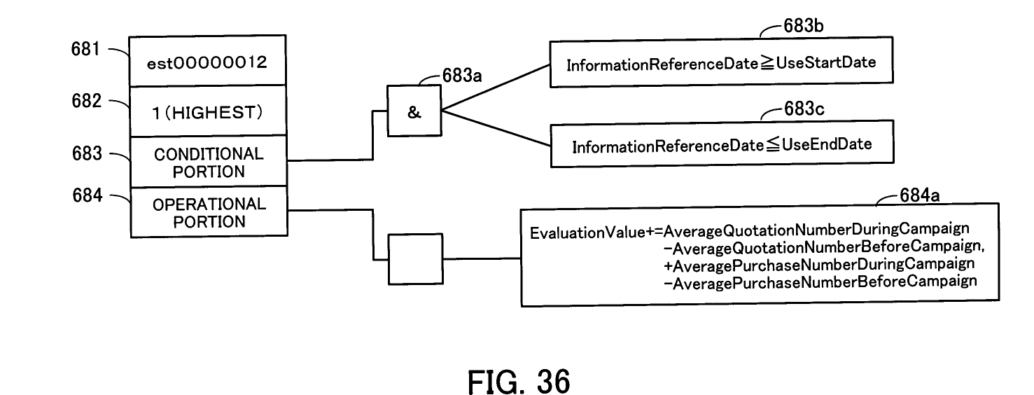

FIG. 36 is a diagram illustrating an example of a rule for re-evaluation of an information group during a campaign period. In this example, increase or decrease in the number of requests for quotation of a target commodity and the number of requests for purchase of the target commodity is reflected in the evaluation value during the campaign period.

The rule for re-evaluation of an information group is constituted by a rule ID 681, a priority 682, a conditional portion 683, and an operational portion 684. In the example of FIG. 36, the rule ID 681 is “est00000012,” and the priority 682 is the highest value “1 (HIGHEST).”

The conditional portion 683 defines a tree structure, which is constituted by a logical connector 683a and conditional nodes 683b and 683c. In the tree structure, the logical connector 683a corresponds to a root, and the conditional nodes 683b and 683c are subordinated to the logical connector 683a.

The logical product (&) is assigned to the logical connector 683a. A first condition, InformationReferenceDate>UseStartDate, is assigned to the conditional node 683b, where the result of the judgement based on the first condition becomes true in the case where a date at which the information item is referred to equals or follows a date at which use of the information item starts (i.e., a date at which the campaign period starts). A second condition,

InformationReferenceDate<UseEndDate,

is assigned to the conditional node 683c, where the result of the judgement based on the second condition becomes true in the case where a date at which the information item is referred to precedes or equals a date at which use of the information item ends (i.e., a date at which the campaign period ends).

The operational portion 684 defines an execution function 684a. The execution function 684a is defined as

EvaluationValue

+=AverageQuotationNumberDuringCampaign

−AverageQuotationNumberBeforeCampaign,

+AveragePurchaseNumberDuringCampaign

−AveragePurchaseNumberBeforeCampaign,

where “+=” is an assignment operator which means that a sum of the values on the right and left sides of the assignment operator is assigned to the variable on the left side, the variable “AverageQuotationNumberDuringCampaign” indicates an average number of quotations issued during the campaign period, the variable “AverageQuotationNumberBeforeCampaign” indicates an average number of quotations issued before the campaign period, the variable “AveragePurchaseNumberDuringCampaign” indicates an average number of purchases requested during the campaign period, and the variable “AveragePurchaseNumberBeforeCampaign” indicates an average number of purchases requested before the campaign period. The execution function 684a defines processing in which the difference in the average number of quotations issued before and after the start of the campaign period and the difference in the average number of purchases requested before and after the start of the campaign period are reflected in the evaluation value.

Next, a rule for evaluating an information provider is explained below.

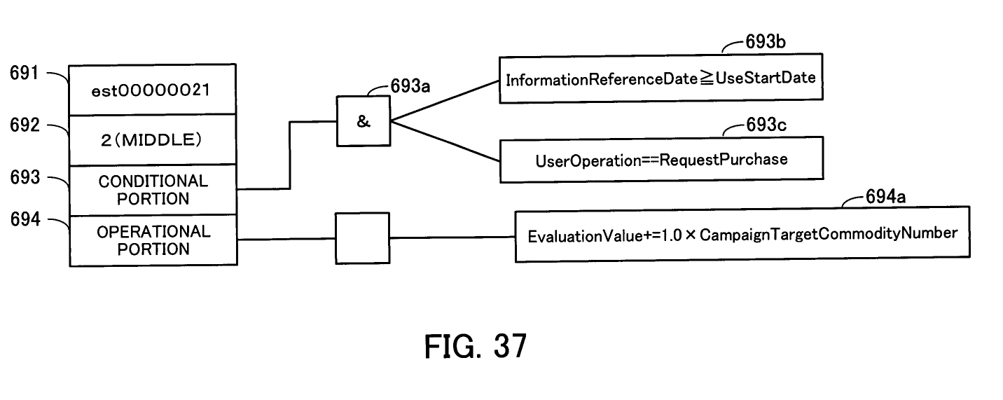

FIG. 37 is a diagram illustrating an example of a rule for evaluation of an information provider, where the evaluation is made in response to a purchase request during a campaign period. In this example, when a request for purchase is received during the campaign period, the evaluation point is increased.

The rule for evaluation of an information provider is constituted by a rule ID 691, a priority 692, a conditional portion 693, and an operational portion 694. In the example of FIG. 37, the rule ID 691 is “est00000021,” and the priority 692 is the second highest value “2 (MIDDLE).”

The conditional portion 693 defines a tree structure, which is constituted by a logical connector 693a and conditional nodes 693b and 693c. In the tree structure, the logical connector 693a corresponds to a root, and the conditional nodes 693b and 693c are subordinated to the logical connector 693a.

The logical product (&) is assigned to the logical connector 693a. A first condition, InformationReferenceDate>UseStartDate, is assigned to the conditional node 693b, where the result of the judgement based on the first condition becomes true in the case where a date at which the information item is referred to equals or follows a date at which use of the information item starts (i.e., a date at which the campaign period starts). A second condition,

UserOperation==RequestPurchase,

is assigned to the conditional node 693c, where the result of the judgement based on the second condition becomes true in the case where an information user inputs a request for purchase by manipulation of a user terminal.

The operational portion 694 defines an execution function 694a. The execution function 694a is defined as

EvaluationValue +=1.0×CampaignedCommodityNumber,

where “+=” is an assignment operator which means that a sum of the values on the right and left sides of the assignment operator is assigned to the variable on the left side, the variable “CampaignedCommodityNumber” indicates the number of target commodities for which a campaign is conducted. The execution function 694a defines processing in which the number of target commodities for which a campaign is conducted is added to the evaluation value.

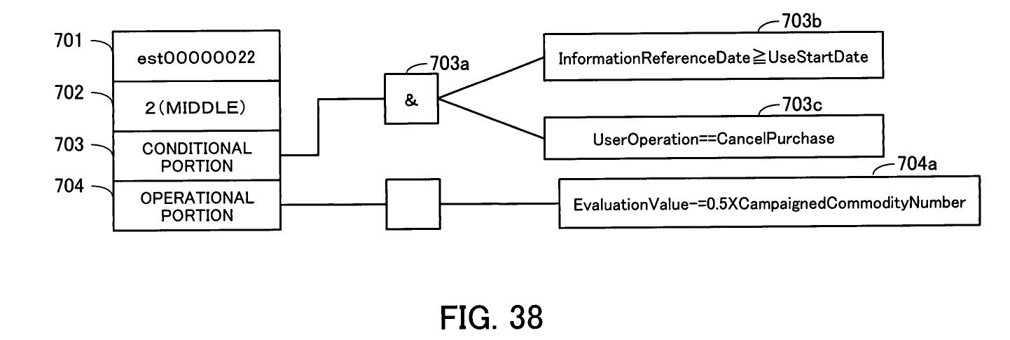

FIG. 38 is a diagram illustrating an example of a rule for evaluation of an information provider, where the evaluation is made in response to cancellation of a purchase request during a campaign period. In this example, the evaluation value is decreased when cancellation of a purchase is executed during a campaign period.

The rule for evaluation of an information provider is constituted by a rule ID 701, a priority 702, a conditional portion 703, and an operational portion 704. In the example of FIG. 38, the rule ID 701 is “est00000022,” and the priority 702 is the second highest value “2 (MIDDLE).”

The conditional portion 703 defines a tree structure, which is constituted by a logical connector 703a and conditional nodes 703b and 703c. In the tree structure, the logical connector 703a corresponds to a root, and the conditional nodes 703b and 703c are subordinated to the logical connector 703a.

The logical product (&) is assigned to the logical connector 703a. A first condition,

InformationReferenceDate>UseStartDate,

is assigned to the conditional node 703b, where the result of the judgement based on the first condition becomes true in the case where a date at which the information item is referred to equals or follows a date at which use of the information item starts (i.e., a date at which the campaign period starts). A second condition,

UserOperation==CancelPurchase,

is assigned to the conditional node 703c, where the result of the judgement based on the second condition becomes true in the case where an information user inputs for cancellation of a purchase by manipulation of a user terminal.

The operational portion 704 defines an execution function 704a. The execution function 704a is defined as

EvaluationValue

−=0.5×campaignedCommodityNumber,

where “−=” is an assignment operator which means that the value on the right side of the assignment operator is subtracted from the value on the left side of the assignment operator, and the obtained difference is assigned to the variable on the left side, the variable “CampaignedCommodityNumber” indicates the number of target commodities for which a campaign is conducted. The execution function 704a defines processing in which half of the number of target commodities for which a campaign is conducted is subtracted from the evaluation value.

As explained above, according to the present invention, it is possible to calculate a highly reliable evaluation value for each of a registered information item, an information group, and an information provider. Therefore, information users can recognize the reliability of provided information by referring to the evaluation values.

The registered information items are automatically delivered to persons who need the registered information items, respectively. Therefore, it is possible to quickly and surely send the respective information items to the persons who need the information items. Further, since each information user can choose a delivery means, it is possible to deliver information by a means suitable for a network environment of the information user.

Since an objective evaluation of each information provider is disclosed, the information users can easily recognize a honest dealer or the like. Therefore, it is possible to exclude wicked dealers, and activate distribution of information by honest dealing.

Each information user can choose only good information items (highly evaluated information items) for use from among an enormous amount of information which are available through the Internet. Therefore, the utilization efficiency of the information increases.

When more highly evaluated information items are more frequently utilized, information providers endeavor to improve the quality of information. Therefore, it is possible to secure the quality of information, and further increase the utilization efficiency of the good information.

It is possible to provide programs which describe details of the processing functions which the information management server 100, the provider terminals 210, 220, 230, and 240, and the user terminals 250, 260, and 270 should have as explained above. When the programs are executed by computers, the processing functions explained above can be realized by the computers.

The programs describing the details of the processing functions can be stored in recording mediums which can be read by the computers. Each of the recording mediums may be a magnetic recording device, an optical disc, an optical magnetic recording medium, a semiconductor memory, or the like. The magnetic recording device may be a hard disk drive (HDD), a flexible disk (FD), a magnetic tape, or the like. The optical disc may be a DVD (Digital Versatile Disc), a DVD-RAM (Random Access Memory), a CD-ROM (Compact Disc Read Only Memory), a CD-R(Recordable)/RW(ReWritable), or the like. The optical magnetic recording medium may be an MO (Magneto-Optical Disc) or the like.

In order to put the programs into the market, for example, it is possible to sell portable recording mediums such as DVDs or CD-ROMs in which the programs are recorded. Alternatively, the programs can be stored in a storage device belonging to a server computer, and transferred through a network from the server computer to the computers which execute the programs.

The computers which execute the programs store the programs in storage devices belonging to the computers, where the programs are originally recorded in, for example, portable recording mediums, or are initially transferred from the server computer. Then, the computers read the programs from the storage devices, and perform processing in accordance with the programs. Alternatively, the computers may directly read the programs from the portable recording mediums for performing processing in accordance with the programs. Further, each of the computers may sequentially perform processing in accordance with each portion of a corresponding one of the program when the computer receives the portion of the program from the server computer.

As explained above, according to the present invention, information items to be delivered are classified into information groups, and evaluation values of the information groups are calculated by applying to the information items evaluation rules which are preset for the information groups. Therefore, the information groups can be evaluated in accordance with appropriate evaluation rules corresponding to attributes of the information items, respectively. Thus, it is possible to obtain highly reliable evaluation results.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A delivery-information management process for managing information which is to be delivered through a network, by using a computer, comprising the steps of:
(a) setting a rule for evaluation of information for an information group;
(b) classifying an information item having a predetermined attribute into said information group;
(c) calculating an evaluation value of the information group by applying said rule for evaluation of information to the information item; and
(d) storing the evaluation value in a database in association with the information group.

2. The delivery-information management process according to claim 1, wherein said rule for evaluation of information defines a formula for calculating said evaluation value based on an evaluation point given by an information user who refers to the information item.

3. The delivery-information management process according to claim 1, wherein said rule for evaluation of information defines a method for calculation of said evaluation value based on statistical information on the information item and an evaluation point given by an information user who refers to the information item.

4. The delivery-information management process according to claim 1, wherein every time a new information item is classified into said information group, the evaluation value of said information group is updated based on an evaluation value of the new information item.

5. The delivery-information management process according to claim 1, wherein an evaluation value of an information provider who provides the information item is calculated based on an evaluation value of the information item.

6. The delivery-information management process according to claim 1, wherein when said information item is inputted, it is determined whether or not inconsistency occurs between said information item and at least one other information item which has been already inputted.

7. The delivery-information management process according to claim 1, wherein a template for information to be registered is sent to an information provider of said information item, and information having a form corresponding to the template is received as said information item.

8. The delivery-information management process according to claim 1, wherein said information item is delivered to a terminal used by an information user, in accordance with a rule for delivery of information, where said rule for delivery is associated with the information user.

9. The delivery-information management process according to claim 1, wherein said rule for evaluation of information is differently set for each of a plurality of evaluation periods.

10. An information management server for managing information which is to be delivered through a network, comprising:
an evaluation-rule setting unit which sets a rule for evaluation of information for an information group;
an information classifying unit which classifies an information item having a predetermined attribute into said information group;
an evaluation-value calculation unit which calculates an evaluation value of the information group by applying said rule for evaluation of information to the information item; and
an information storing unit which stores the evaluation value in a database in association with the information group.

11. A delivery-information management program for managing information which is to be delivered through a network, said delivery-information management program makes a computer perform a processing sequence which comprises the steps of:
(a) setting a rule for evaluation of information for an information group;
(b) classifying an information item having a predetermined attribute into said information group;
(c) calculating an evaluation value of the information group by applying said rule for evaluation of information to the information item; and
(d) storing the evaluation value in a database in association with the information group.

12. A computer-readable recording medium which stores a delivery-information management program for managing information which is to be delivered through a network, said delivery-information management program makes a computer perform a processing sequence which comprises the steps of:
(a) setting a rule for evaluation of information for an information group;
(b) classifying an information item having a predetermined attribute into said information group;
(c) calculating an evaluation value of the information group by applying said rule for evaluation of information to the information item; and
(d) storing the evaluation value in a database in association with the information group.
